(19) United States
(12) Patent Application Publication
(10) Pub. No.: US 2026/0370481 A1
(43) Pub. Date: Nov. 19, 2026

(54) Transparent Verifiable Random Function for Artificial Intelligence Systems

(71) Applicant: Veriton AS, 1394 Nesbru (NO)

(72) Inventor: Bjorn Vidar Hauge, 1337 Sandvika (NO)

(73) Assignee: Veriton AS, 1394 Nesbru (NO)

(21) Appl. No.: 19/678,421

(22) Filed: May 15, 2026

Related U.S. Application Data
(60) Provisional application No. 63/806,881, filed on May 16, 2025.

(51) Int. Cl. H04L 9/32; H04L 9/08

(52) U.S. Cl. CPC H04L 9/3218; H04L 9/0869

(57) ABSTRACT

A method, system, and apparatus are provided for producing verifiable random outputs from publicly accessible cryptographic source data. A source selection rule and extraction specification are made publicly available, cryptographically committed, or otherwise deterministically knowable before a public consensus derived cryptographic source value is confirmed, finalized, or otherwise fixed. A computing device retrieves the source value, verifies that it satisfies the source selection rule and an applicable confirmation, finality, or consensus validity condition, and applies the extraction specification to produce a verifiable random output within a target range. Verification information enables a third party to reproduce the output from public source data without a secret cryptographic key or trusted randomness oracle. In some embodiments, source values are normalized across multiple encoding classes, aggregated into an entropy root, or used to derive domain separated seeds for downstream stochastic operations.

### CROSS-REFERENCE TO RELATED CASES

The present application claims the benefit of U.S. Provisional Application No. 63/806,881, filed on May 16, 2025, which is hereby incorporated by reference in its entirety.

### TECHNICAL FIELD

The present invention relates to the foundational verifiable randomness layer of AI accountability infrastructure: a system, method, and computer-readable medium for extracting cryptographically secure, independently verifiable entropy from confirmed cryptographic output data of any distributed ledger system through a universal extraction interface covering an effectively infinite family of deterministic extraction methods, applied to hash output data in any encoding format—including but not limited to lowercase hexadecimal, uppercase hexadecimal, mixed-case hexadecimal, Base58, Base64, Base64URL, Base32, Bech32, Bech32m, balanced ternary trytes, ZK-circuit-native field element representations, post-quantum large hash outputs, and any encoding format produced by distributed ledger systems not yet in existence at the time of filing—with the downstream capability to supply verified entropy to all thirteen identified stochastic operation domains of AI training and inference through domain-partitioned seed derivation, and with multi-transaction ensemble extraction, bidirectional and interleaved sequence reading, and cross-blockchain positional character alignment providing an unbounded and ever-expanding family of independently verifiable extraction methods.

### BACKGROUND

Existing systems for producing random or pseudo-random values fall into three structural categories, each of which shares a common architectural weakness. The present invention constitutes a structurally distinct fourth category that does not share said weakness.

### A. Category 1—Oracle-Generated Verifiable Random Function (VRF) Systems

The first category is oracle-generated Verifiable Random Function (VRF) systems, exemplified by Chainlink VRF (see US Patent Application Publication No. 2023/0318857, now issued as U.S. Pat. No. 12,401,532; published Chainlink VRF v2 and VRF 2.5 specifications; and Chainlink VRF contract source code), Pyth Entropy, API3 QRNG, Band Protocol VRF, drand, Algorand VRF (see WO 2017/192837), nChain (see US 2022/0410017), Thunder Token (see WO 2020/102456), and related oracle-based randomness services. These systems generate a 256-bit or larger cryptographic random value off-chain using one or more secret keys held by an oracle node or oracle network, transmit a proof of said generation to a consumer smart contract or application, and return said cryptographic value. The consumer is then required to apply mathematical post-processing—typically modulo reduction, rejection sampling, range mapping, bitmask extraction, floor division, hash-to-range mapping, or bucketization—to transform the 256-bit value into a usable target range. Verification of the VRF proof attests only that a party holding a particular public key produced the large value; it does not attest that the large value was produced without cherry-picking among candidate seeds, nor that the consumer's range-bounding post-processing was performed correctly.

### B. Category 2—Hardware Entropy Sources

The second category is hardware entropy sources, including Intel RDRAND/RDSEED instructions, ARM TrustZone true random number generators, Apple Secure Enclave entropy sources, IBM quantum random number generators, ID Quantique quantum devices, and related systems (for example, Boeing U.S. Pat. No. 9,465,582). These systems generate physical-entropy bits opaque to the consuming application. The consumer again applies mathematical post-processing to obtain a value in the target range, and must additionally trust the hardware root of trust and the on-device conditioning firmware. No external verifier can independently confirm that a specific output byte was produced by the hardware source as opposed to being substituted by a compromised driver, operating system, or hypervisor.

### C. Category 3-Deterministic Pseudo-Random Number Generators (PRNGs)

The third category is deterministic pseudo-random number generators (PRNGs), including Mersenne Twister, Philox, ThreeFry, linear-congruential generators, xoshiro and xorshift variants, chaotic-system-seeded PRNGs, and patented financial-trading PRNG systems (for example, the Morgan Stanley U.S. Pat. No. 5,732,138 family). These systems produce deterministic output sequences from a hidden internal state, and likewise require consumer-side post-processing to yield values within a target range. A consumer of a PRNG cannot independently verify that the operator of the PRNG used the committed seed—the internal state is observable only to the operator, which creates an irreducible cherry-pick surface.

### D. Common Structural Weakness of Categories 1, 2, and 3

All three of the foregoing categories share the structural property that the consumer of the randomness must apply a post-extraction mathematical transformation of a larger entropy value to obtain a usable output. This post-processing occurs in consumer code that is not directly verifiable by end-users; introduces statistical bias whenever the target range is not a clean divisor of the entropy bit-width; and requires end-users to trust the consumer's implementation. Even when a cryptographic “verifiable random function” proof is provided, such a proof attests only that the large value was generated by a party holding a particular public key—it does not attest that the large value was produced without cherry-picking among candidate seeds, nor that the consumer's range-bounding post-processing was performed correctly. The consumer, the oracle, and (in the case of PRNGs) the operator retain unilateral ability to influence which large value is used and how it is reduced.

### SUMMARY

The present disclosure describes a structurally distinct fourth category. This category, ledger-data extractive derivation, does not generate entropy and does not produce a larger random value requiring post-processing. Instead, the present invention extracts output values directly within the target range from transaction hashes already committed to an immutable public distributed ledger through a consensus mechanism, using a deterministic extraction specification that is published or otherwise deterministically knowable prior to confirmation of the transaction hash from which the extraction is performed. The extraction itself produces the final output; no post-extraction transformation of a cryptographic random value of greater bit-width than required to represent the target range is performed. Verification is performed by any third party with public blockchain read access, using only the transaction hash and the extraction specification, without access to any secret cryptographic key, without interaction with any oracle or oracle network, and without execution of any off-chain computation. This differs from the category1, 2, and 3 background prior art at the mechanism level and it answers a different question. Rather than generating a new entropy value and then transforming it into a target range, ledger-data extractive derivation reads a value that is already permanent, public, and consensus-verified, at character positions selected by a pre-published specification, such that the selected characters directly constitute the output. This operates on existing, unassociated ledger; it therefore cannot cherry-pick, cannot omit, cannot bias, and cannot require trust in any issuing operator.

One embodiment provides a method for producing a random integer directly within a target range [a, b] from a confirmed public distributed ledger transaction hash, by (a) identifying an immutable public distributed ledger transaction hash confirmed by a consensus mechanism; (b) selecting, from said transaction hash, a sequence of character positions determined by an extraction specification published or otherwise deterministically knowable prior to confirmation of said transaction hash; (c) producing the random integer directly within the target range from the characters at said selected positions, wherein the method performs no post-extraction transformation of a cryptographic random value of greater bit-width than required to represent the target range; and (d) whereby any third party with access only to the transaction hash and the extraction specification can independently reproduce the random integer.

A second embodiment provides a plurality of extraction-specification families, including fixed-position selection, sequential contiguous window selection, interval-based selection, bidirectional selection, character-type filtered selection, multi-transaction aggregation, cross-ledger aggregation, and encoding-family-specific selection.

A third embodiment provides a universal extraction interface, normalization and encoding-substrate preservation module, and domain-partitioned seed derivation module, together producing an entropy proof object which any third party can verify using only the transaction hash identifiers referenced in said proof and the extraction specifications referenced in said proof.

The invention has been reduced to practice across twenty-seven distributed ledger networks and more than one hundred twenty-four million confirmed transactions. Empirical measurements across the eight registered encoding classes demonstrate chi-squared p-values in excess of 0.9997 against the null hypothesis of non-uniform distribution; measured maximum per-bucket deviation of 0.003 parts per mil; and Shannon entropies consistent with the theoretical maxima of each encoding (3.819/4.000 for hexadecimal, 5.314/5.858 for Base58).

### BRIEF DESCRIPTION OF THE DRAWINGS

FIG. 1 is a system architecture diagram showing the five functional modules.

FIG. 2 is a flow chart showing one embodiment of the present invention

FIG. 3 is an encoding class taxonomy diagram illustrating encoding families, together with their respective alphabets, symbol counts, and theoretical bit-density characteristics.

FIG. 4 illustrates multi-transaction ensemble extraction, showing the pipeline from a plurality of N transaction hashes retrieved from one or more distributed ledger networks through vertical-column and diagonal cross-ledger positional alignment to produce a combined entropy contribution.

FIG. 5 illustrates bidirectional and interleaved sequence reading of a transaction hash, showing forward traversal, reverse traversal, and interleaved combination patterns applicable to any encoding class.

FIG. 6 illustrates cross-blockchain positional alignment of transaction hashes from a plurality of distributed ledger networks, showing character-by-character positional mapping across networks producing correlated extraction positions.

FIG. 7 illustrates the cross-family aggregation method, showing parallel extraction paths across hexadecimal, Base58, balanced ternary, and ZK field element encoding families, with aggregation into a unified entropy root.

FIG. 8 illustrates the domain-partitioned seed derivation function seed (domain, step, rank)=SHA3-256 (entropy_root∥domain_tag∥step∥session_id∥rank∥sub_step) for each of the thirteen identified stochastic operation domains of AI training and inference.

FIG. 9 illustrates the verification proof structure (entropy_proof.json), showing the mandatory data fields comprising a complete attestation object: session_id, source_refs, extraction specification, combined_root, seed_commitments, and C_entropy commitment constituting the mandatory public input to zero-knowledge compliance proofs.

FIG. 10 is an empirical convergence chart showing uniformity of extracted values across twenty-seven distributed ledger networks and one hundred twenty-four million confirmed transactions, comprising: Panel A, chi-squared p-values by encoding class (all classes p>0.9997 against the null hypothesis of non-uniform distribution); Panel B, measured Shannon entropy versus theoretical maximum by encoding class; Panel C, convergence of maximum per-bucket deviation versus transaction sample size on a logarithmic scale, demonstrating convergence to 0.003 parts per million at full sample size; and Panel D, network coverage summary.

### DETAILED DESCRIPTION

The present invention is a Category 4 system as defined in the Background section above. All embodiments described below operate on confirmed public distributed ledger transaction hashes and produce integer outputs directly within a target range by selecting characters from said transaction hashes according to an extraction specification published or otherwise deterministically knowable prior to confirmation of the relevant transaction hash. No embodiment described below generates a cryptographic random value of greater bit-width than required to represent the target range and then applies post-extraction transformation of such a value; rather, every embodiment extracts the output directly from characters at positions in the transaction hash specified by the extraction specification. Where the term “modular reduction” or equivalent appears below, it refers to reduction of the transaction hash itself as pre-existing ledger data, not reduction of a value generated by the present invention.

### 1. SYSTEM ARCHITECTURE OVERVIEW

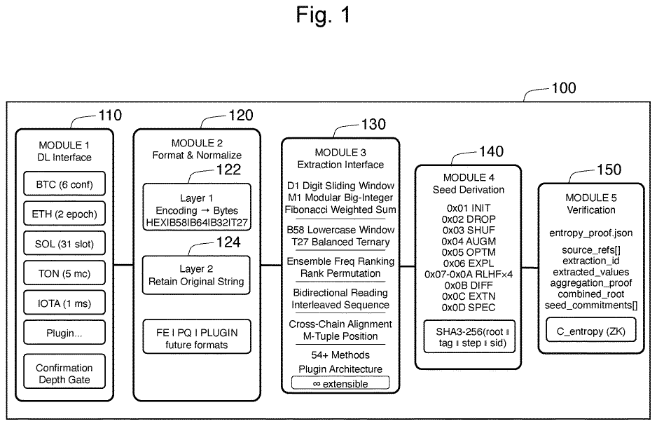

FIG. 1 illustrates an example transparent verifiable randomness system 100. The system 100 may be implemented by one or more computing devices having one or more processors, memory storing instructions executable by the one or more processors, and one or more network interfaces for communicating with public distributed ledger systems, distributed ledger nodes, light client services, validator interfaces, block explorers, storage networks, randomness beacon services, or other public cryptographic data sources. The instructions stored in memory may configure the one or more computing devices to perform the functions of the distributed ledger interface module 110, the universal format detection and normalization module 120, the universal extraction function interface module 130, the domain partitioned seed derivation module 140, and the verification and attestation module 150. Although these modules are shown within the system 100 as separate functional blocks, the modules may be implemented in a single computer system, across multiple networked computer systems, as local software, as cloud based services, as smart contract logic, as firmware, as hardware logic, or as any suitable combination thereof.

The distributed ledger interface module 110 is shown as including interfaces or configuration data for a plurality of example ledger systems. In the illustrated embodiment, the distributed ledger interface module 110 includes Bitcoin with a six confirmation threshold, Ethereum with a two epoch threshold, Solana with a thirty-one slot threshold, TON with a five masterchain block threshold, IOTA with a one milestone threshold, and a plugin interface for additional or future ledger systems. These examples indicate that different distributed ledger systems may have different confirmation or finality rules, and that the distributed ledger interface module 110 may apply a network specific validity gate before a ledger value is accepted for extraction. The confirmation depth gate shown in module 110 represents logic for determining whether a transaction hash, block hash, checkpoint value, or other public cryptographic source value has reached the required level of consensus confirmation for the selected ledger system.

The universal format detection and normalization module 120 is shown as performing a two layer normalization process. In the illustrated embodiment, a first layer 122 converts an encoded source value into bytes for extraction methods that operate on a canonical byte representation. The first layer 122 is shown as supporting example encoding families including HEX, B58, B64, B32, and T27. A second layer 124 retains the original string representation of the source value for extraction methods that operate on the native encoded representation. Module 120 is also shown as supporting field element representations, post quantum representations, and plugin defined future formats. These features indicate that the system 100 is not limited to a single blockchain encoding format, and that both a normalized byte representation and an original encoded representation may be preserved for later use by extraction module 130.

The universal extraction function interface module 130 is shown as an extraction dispatch and registration layer. In the illustrated embodiment, module 130 includes representative extraction functions such as D1 digit sliding window, M1 modular big integer extraction, Fibonacci weighted sum, Base58 lowercase window extraction, T27 balanced ternary extraction, ensemble frequency ranking, rank permutation extraction, bidirectional reading, interleaved sequence extraction, cross chain alignment, and M tuple position extraction. Module 130 is also shown as supporting fifty-four or more methods and a plugin architecture with extensible extraction functions. These entries in module 130 illustrate that the system 100 may select from multiple deterministic extraction functions, while using a common interface that allows the selected extraction function and its public parameters to be recorded and reproduced.

The domain partitioned seed derivation module 140 is shown as deriving seeds for a plurality of downstream stochastic domains. In the illustrated embodiment, module 140 includes domain identifiers for INIT, DROP, SHUF, AUGM, OPTM, EXPL, four RLHF related domains, DIFF, EXTN, and SPEC. Module 140 is also shown as applying a SHA3 256 based derivation using an entropy root, a domain tag, a step value, and a session identifier. These entries illustrate that an extracted value, or an entropy root derived from one or more extracted values, may be separated into reproducible domain specific seeds for downstream uses. The specific use of these derived seeds, including their use in artificial intelligence training or inference systems, is described in greater detail below.

The verification and attestation module 150 is shown as generating a machine readable proof object, such as entropy_proof.json. In the illustrated embodiment, the proof object includes source references, an extraction identifier, extracted values, an aggregation proof, a combined root, seed commitments, and a C entropy commitment. These entries illustrate that module 150 records information sufficient to support later verification of the extraction process and, where applicable, verification of downstream seed derivation or commitment generation. The proof object may be stored, transmitted, logged, digitally signed, anchored to a ledger, or otherwise made available for audit or third party reproduction.

The arrangement shown in FIG. 1 provides a modular architecture in which ledger access and confirmation checking are handled by module 110, format handling is performed by module 120, deterministic extraction is performed by module 130, optional seed derivation is performed by module 140, and verification information is generated by module 150. The particular ledger systems, encoding families, extraction methods, domain tags, proof fields, and confirmation thresholds shown in FIG. 1 are examples. Other embodiments may include additional ledger systems, different confirmation or finality thresholds, additional encoding classes, additional extraction functions, additional downstream seed domains, or different proof fields while retaining the same general modular architecture.

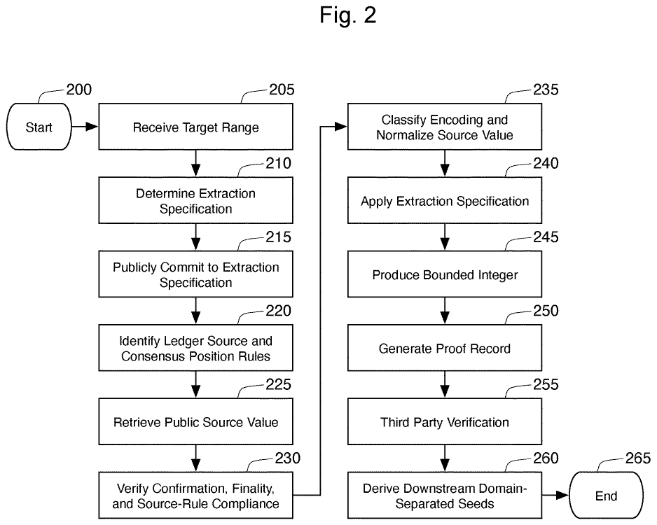

FIG. 2 illustrates an example method 200 for producing a bounded random integer from a public consensus confirmed cryptographic source value. In general, the method 200 uses the modular architecture of system 100 to define an extraction process before the relevant source value is accepted, obtain the source value from a public distributed ledger or other public consensus system, normalize the source value into a representation suitable for extraction, apply the extraction process, and generate proof information that allows a third party to reproduce the same result. In some embodiments, the method 200 may also derive downstream domain separated seeds from the extracted value or from an entropy root derived from the extracted value.

At step 205, the system 100 receives a target range for the bounded random integer to be produced by the method 200. The target range may be expressed by a lower bound and an upper bound, such as a range from an integer a to an integer b, and defines the permissible output values for the extraction. The target range may be received from a requesting application, selected according to a stored configuration, determined from a type of stochastic operation being performed, or provided as part of an extraction session request. In the architecture of FIG. 1, the target range may be supplied to the universal extraction function interface module 130 so that module 130 can select or parameterize an extraction function capable of producing an output within the target range.

At step 210, the system 100 determines an extraction specification for producing an integer within the target range. The extraction specification defines the deterministic procedure that will later be applied to a public source value. The extraction specification may identify an extraction function, an encoding substrate, selected character positions, selected symbol positions, selected byte positions, a window size, an alphabet mapping, a field element mapping, an ordering rule, a rejection rule, a fallback rule, a source selection rule, or any other public parameter needed to reproduce the extraction. In the architecture of FIG. 1, step 210 may be performed at least in part by the universal extraction function interface module 130, which may maintain or access a registry of extraction functions and corresponding parameter schemas. The extraction specification is preferably complete enough that a verifier having the later obtained source value and the extraction specification can reproduce the same bounded integer without access to private information.

In some embodiments, the extraction specification determined at step 210 may also identify the representation of the source value to be used during extraction. For example, the extraction specification may indicate that the extraction function is to operate on an original encoded string preserved by second layer 124 of the normalization module 120, or on a canonical byte representation produced by first layer 122 of the normalization module 120. The extraction specification may also identify a specific encoding family, such as HEX, B58, B64, B32, T27, a field element representation, a post quantum representation, or a plugin defined format. By including representation information in the extraction specification, the system 100 can avoid later ambiguity regarding whether the extraction should be performed on a native encoded string, normalized bytes, or another representation.

At step 215, the system 100 publicly commits to the extraction specification determined at step 210. The commitment may be made by publishing the extraction specification, publishing a cryptographic hash of the extraction specification, storing the extraction specification or a commitment to it in a manifest, writing the extraction specification or commitment to an audit log, anchoring the specification or commitment to a distributed ledger, digitally signing the specification or commitment, or otherwise making the specification deterministically knowable to a third party. In some embodiments, the commitment is generated or recorded by the verification and attestation module 150, while the underlying extraction specification is generated or selected by the universal extraction function interface module 130.

The commitment at step 215 is preferably made before the public source value used for extraction is confirmed, finalized, or otherwise fixed in a manner that would permit the system operator to select extraction parameters based on the contents of the source value. This timing helps prevent an operator from observing a transaction hash, block hash, checkpoint digest, beacon value, or other source value and then choosing extraction parameters that yield a favorable output. In some embodiments, the commitment includes or references both the extraction procedure and the target range received at step 205, so that the range and extraction rule are fixed before the source value is accepted for extraction. The commitment may later be included in a proof record generated by the verification and attestation module 150 so that a verifier can determine whether the extraction specification was fixed at the required time.

At step 220, the system 100 identifies ledger source and consensus position rules. These rules define the public source from which the cryptographic source value will be obtained and the deterministic criterion by which the particular source value will be selected. The rules may identify a distributed ledger system, a storage network, a randomness beacon, or another public consensus source, and may further identify a block height, slot, epoch, round, checkpoint, tipset, transaction index, event position, beacon round, content reference, or other consensus ordering criterion or public source selection criterion. In the architecture of FIG. 1, the distributed ledger interface module 110 may use these rules to determine which public network or data source should be queried and which candidate value is eligible for extraction.

The ledger source and consensus position rules identified at step 220 preferably prevent selection among multiple candidate source values after their contents are known. For example, the rules may specify the first transaction hash satisfying a public criterion in a particular block, the block hash of a particular block height, the checkpoint digest for a particular checkpoint, the output of a particular beacon round, or another deterministic source selection rule. In some embodiments, these rules are included in the extraction specification determined at step 210 and publicly committed at step 215. In other embodiments, these rules are separately committed to, but are associated with the same extraction session. The verification and attestation module 150 may record the ledger source and consensus position rules so that a third party can later confirm that the retrieved source value was selected according to the same rules used by the system 100.

At step 225, the system 100 retrieves a public source value according to the ledger source and consensus position rules identified at step 220. The public source value may be a transaction hash, a block hash, a transaction Merkle root, a checkpoint digest, a smart contract event hash, a randomness beacon value, a signature, a content identifier, a tipset related value, or another cryptographic value made available through a public consensus process. In the architecture of FIG. 1, the distributed ledger interface module 110 may retrieve the public source value by communicating through a network interface with one or more public ledger nodes, light client services, validator interfaces, archival nodes, block explorers, storage network interfaces, randomness beacon services, or other public data sources. The retrieved value may be treated as a candidate source value until the system 100 determines that the value satisfies the applicable source selection rule and confirmation or finality requirement.

In some embodiments, the distributed ledger interface module 110 retrieves additional information associated with the public source value. This additional information may include a block header, transaction inclusion proof, Merkle proof, receipt, event log, checkpoint certificate, validator signature, beacon signature, storage proof, finality proof, timestamp, block height, slot, epoch, round, checkpoint, tipset, transaction index, or other public information that can be used to verify the source value. The distributed ledger interface module 110 may cache the retrieved information, associate the retrieved information with an extraction session, and provide the retrieved information to the verification and attestation module 150 for later inclusion in a proof record.

At step 230, the system 100 verifies confirmation, finality, and source rule compliance. The distributed ledger interface module 110 first determines whether the candidate source value retrieved at step 225 is the value selected by the ledger source and consensus position rules identified at step 220. For example, the module 110 may determine whether the source value corresponds to the specified block height, slot, epoch, round, checkpoint, tipset, transaction index, event position, beacon round, content reference, or other public source selection criterion. This verification helps ensure that the system 100 did not select a different candidate value after observing the contents of multiple possible source values.

The distributed ledger interface module 110 also determines whether the candidate source value has reached the required confirmation, finality, or consensus validity condition for the selected public source. As shown in FIG. 1, different ledger systems may have different network specific thresholds, such as six confirmations for Bitcoin, two epochs for Ethereum, thirty-one slots for Solana, five masterchain blocks for TON, one milestone for IOTA, or another threshold defined for a plugin supported source. The particular threshold used in a given embodiment may depend on the ledger system, the type of source value, the desired security level, or a stored configuration. If the candidate source value does not satisfy the applicable source selection rule or confirmation requirement, the system 100 may wait for additional confirmation, retrieve updated public information, select a replacement value only if permitted by the previously committed rules, or terminate the extraction session.

At step 235, the system 100 classifies the encoding of the verified source value and normalizes the source value. In the architecture of FIG. 1, this step may be performed by the universal format detection and normalization module 120. The module 120 may determine whether the source value is represented using an encoding family such as HEX, B58, B64, B32, T27, a field element representation, a post quantum representation, or a plugin defined format. The classification may be based on the alphabet used in the source value, the length of the source value, a prefix or network identifier, metadata obtained from the distributed ledger interface module 110, a source type identified in the extraction specification, or a format detector associated with a plugin.

After classifying the encoding, the universal format detection and normalization module 120 normalizes the source value for use by the extraction function interface module 130. In the embodiment shown in FIG. 1, first layer 122 converts the source value into a canonical byte representation for extraction methods that operate on bytes or numerical values derived from bytes. Second layer 124 preserves the original encoded string for extraction methods that operate on native characters, symbols, alphabet positions, character classes, or other encoding specific features. The system 100 may store both representations, and the extraction specification may identify which representation is to be used. Preserving both representations allows the same public source value to support extraction functions that are independent of encoding and extraction functions that intentionally rely on the original encoding.

At step 240, the system 100 applies the extraction specification to the source value as classified and normalized at step 235. In the architecture of FIG. 1, the universal extraction function interface module 130 may select the extraction function identified by the extraction specification and may supply the public parameters associated with that extraction function. The module 130 may then apply the extraction function to the representation identified by the extraction specification, such as the canonical byte representation generated by first layer 122 or the original encoded string retained by second layer 124. Because the extraction specification was previously committed at step 215, the extraction function and its parameters are not selected based on the contents of the verified source value.

The extraction specification may cause the extraction function interface module 130 to read or process the source value in a number of deterministic ways. For example, the module 130 may select characters at specified positions, extract a sliding window, map characters to alphabet indices, read bytes at specified byte positions, process a field element, count character classes, apply a balanced ternary mapping, read the source value in a forward order, read the source value in a reverse order, form an interleaved sequence, aggregate multiple source values, or apply a plugin defined extraction function. The particular operation performed at step 240 is reproducible from the public source value and the public extraction specification.

At step 245, the system 100 produces a bounded integer within the target range received at step 205. The bounded integer is produced by applying the committed extraction specification to the verified source value, and therefore the same verified source value and the same extraction specification produce the same bounded integer when applied by a verifier. In some embodiments, the bounded integer is formed directly from selected characters, symbols, bytes, alphabet indices, field element portions, or other selected material specified by the extraction function. In other embodiments, the bounded integer is produced by a deterministic mapping defined by the extraction specification, provided that the mapping is public and reproducible.

The bounded integer produced at step 245 may be returned to a requesting application, stored in association with an extraction session, supplied to a downstream process, or used as one input to an aggregation or seed derivation process. In some embodiments, the bounded integer is the final output of the method 200. In other embodiments, the bounded integer is combined with one or more other extracted values to form an entropy root, or is supplied to the domain partitioned seed derivation module 140 for generation of one or more downstream domain separated seeds.

At step 250, the system 100 generates a proof record for the extraction. In the architecture of FIG. 1, the proof record may be generated by the verification and attestation module 150. The proof record may identify the target range, the extraction specification, the commitment to the extraction specification, the source selection rule, the selected public source, the consensus position, the retrieved source value or a reference to the retrieved source value, the confirmation or finality evidence, the detected encoding class, the normalization method, the extraction function, the public extraction parameters, and the bounded integer produced at step 245. The proof record may also include any additional information needed for a third party to determine that the extraction specification and source selection rule were fixed before the source value was accepted for extraction.

In some embodiments, the proof record is generated as a machine readable proof object, such as the entropy_proof.json object shown in FIG. 1. The proof object may include source references, an extraction identifier, extracted values, an aggregation proof, a combined root, seed commitments, and a C entropy commitment when such values are used by the embodiment. The proof record may be stored locally, transmitted to a requesting application, written to an audit log, digitally signed, anchored to a distributed ledger, included in a regulatory attestation, or otherwise made available for third party reproduction and verification.

At step 255, the method 200 permits third party verification of the bounded integer produced at step 245 and the proof record generated at step 250. A verifier may obtain the proof record generated by the verification and attestation module 150 and may use the proof record to identify the public source value, the committed extraction specification, the source selection rule, the applicable confirmation or finality requirement, the encoding classification, the normalization procedure, and the extraction function used to produce the bounded integer. The verifier may then retrieve the same public source value, or verify the public source value from the source reference in the proof record, using public ledger access or another public consensus data source.

During verification, the verifier may determine whether the extraction specification and source selection rule were publicly committed or otherwise made deterministically knowable before the source value was accepted for extraction. The verifier may also determine whether the retrieved source value satisfies the source selection rule and whether the source value reached the applicable confirmation, finality, or consensus validity requirement. The verifier may then classify and normalize the source value in the same manner as the universal format detection and normalization module 120, apply the same extraction specification using the same public parameters as the universal extraction function interface module 130, and compare the resulting integer with the bounded integer identified in the proof record. If the reproduced integer matches the integer identified in the proof record, the verifier can confirm that the bounded integer was derived from the identified public source value in accordance with the committed extraction specification. The verification may be performed without access to a secret cryptographic key and without reliance on a trusted randomness oracle.

At step 260, the method 200 may derive downstream domain separated seeds from the bounded integer, from an extracted entropy value, or from a combined entropy root derived from one or more extracted values. This step may be performed by the domain partitioned seed derivation module 140. In some embodiments, the domain partitioned seed derivation module 140 receives the extracted value or combined entropy root and applies a cryptographic derivation function using domain separation information. The domain separation information may include a domain tag, a step index, a session identifier, a worker rank, a sub step identifier, or another value that distinguishes one downstream stochastic use from another.

The downstream seeds derived at step 260 may be used to supply reproducible randomness to one or more downstream operations. As shown in FIG. 1, example domain tags may correspond to initialization, dropout, shuffling, augmentation, optimizer perturbation, exploration, reinforcement learning from human feedback operations, diffusion operations, extended reasoning operations, speculative decoding operations, or other stochastic domains. The use of different domain tags allows the same verified entropy source to support multiple downstream uses while reducing the risk that a seed intended for one domain will be reused in another domain. In some embodiments, commitments to the downstream seeds, rather than the seeds themselves, may be included in the proof record generated at step 250, so that later verification can confirm that the downstream seeds were derived from the verified entropy source without necessarily revealing each seed value.

At step 265, the method 200 ends. At the completion of the method 200, the system 100 may have produced a bounded integer within the target range, generated a proof record permitting independent reproduction of the bounded integer, permitted third party verification of the extraction, and, where applicable, derived one or more downstream domain separated seeds. In embodiments where downstream seed derivation is not required, the method 200 may end after generation of the proof record or after third party verification. In embodiments where downstream stochastic operations are performed, the derived seeds may be supplied to the appropriate downstream application, stored in association with the extraction session, or represented by seed commitments in the proof record.

### 2. DISTRIBUTED LEDGER INTERFACE MODULE 110

As introduced above with reference to FIG. 1, the distributed ledger interface module 110 obtains public consensus derived cryptographic source values and determines whether those values are eligible for use by the extraction interface module 130. The operation of module 110 is also reflected in FIG. 2, including identification of ledger source and consensus position rules, retrieval of a public source value, and verification of confirmation, finality, and source rule compliance. This section provides additional examples of the distributed ledger systems and public source values that may be handled by module 110.

The system 100 may support confirmed cryptographic output data from any distributed ledger system satisfying source eligibility requirements. In some embodiments, the cryptographic output data is determined by distributed consensus outside the control of any single operator, is publicly accessible from independent nodes or other public network interfaces, and is computationally infeasible to modify after a specified minimum confirmation depth, finality event, checkpoint, milestone, or other consensus validity condition. These requirements allow module 110 to obtain a source value that is both public and resistant to unilateral alteration by the party requesting or operating the randomness extraction.

Examples of supported networks may include, without limitation, proof of work networks, proof of stake networks, BFT networks, DAG based networks, hybrid consensus networks, ZK native networks, decentralized storage networks, randomness beacon networks, and future distributed consensus systems that produce public cryptographic output data. Proof of work examples may include Bitcoin using SHA 256d, Bitcoin Cash, Litecoin using Scrypt, Monero using RandomX, Zcash using Equihash, and Dogecoin. Proof of stake examples may include Ethereum using Keccak 256, Cardano using BLAKE2b 256, Solana using SHA 256 with Ed25519 signatures, Polkadot using BLAKE2b 256, Avalanche, Cosmos, Algorand using SHA 512 256, Near Protocol, Sui, Aptos, and Fantom. BFT, DAG, or hybrid examples may include TON using SHA 256, IOTA using Curl P 81 ternary, Hedera Hashgraph using SHA 384, and Stellar using SHA 256 with Strkey encoding. ZK native examples may include Starknet using Pedersen and Poseidon hash functions, zkSync Era using Poseidon over BN254, and other systems that produce field element or circuit native cryptographic output data. The system may also support any distributed consensus system producing public cryptographic output data not yet in existence at the time of filing.

The public source value obtained by module 110 need not be limited to a conventional transaction hash. In various embodiments, the public source value may be a transaction hash, a block hash, a transaction Merkle root, a receipt root, a state root, a checkpoint digest, a smart contract event hash, a wallet creation transaction hash, a contract creation transaction hash, a randomness beacon signature, a randomness beacon output, a content identifier, a tipset related value, a validator signed digest, a storage proof value, or another cryptographic value that is fixed or ordered by a public consensus process.

In some embodiments, module 110 includes a plugin interface for supporting additional networks or source types. A plugin may define how to connect to a particular public consensus source, how to identify source values, how to evaluate source selection rules, how to determine confirmation or finality, and how to retrieve proof material. The plugin interface allows the system 100 to support additional distributed ledger systems, decentralized storage systems, randomness beacons, or future consensus systems without changing the overall operation of method 200.

### 3. FORMAT AND NORMALIZATION MODULE 120

As introduced above with reference to FIG. 1, the universal format detection and normalization module 120 receives a public source value obtained by the distributed ledger interface module 110 and prepares that source value for use by the extraction interface module 130. Module 120 allows the system 100 to operate across distributed ledger systems that use different encodings, alphabets, output lengths, and cryptographic data formats. Rather than requiring a separate extraction pipeline for each network, module 120 classifies the source value and provides one or more representations that may be used by the extraction specification.

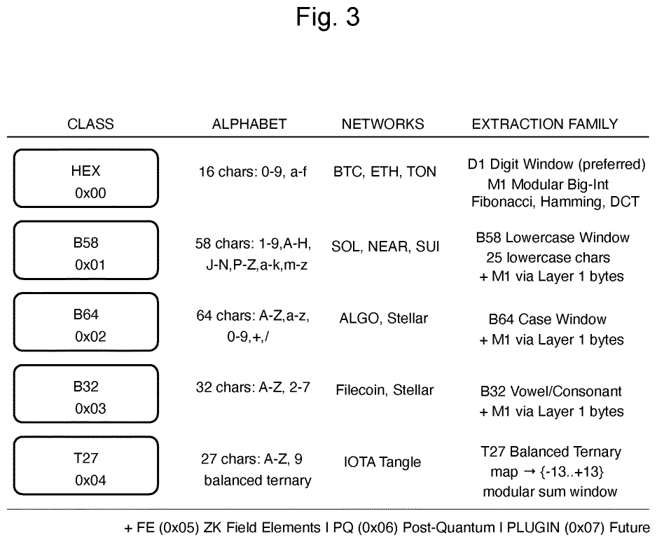

As shown in FIG. 3, five primary encoding classes are identified. Class HEX, which includes lowercase, uppercase, or mixed case hexadecimal, has a character alphabet of {0 to 9, a to f} or {0 to 9, A to F}. Class HEX is used by Bitcoin, Ethereum, TON, Cardano, Polkadot, Hedera, and all EVM compatible chains. A Class HEX value may include 64 characters for 256 bit hashes, 96 characters for 384 bit hashes, such as Hedera, and 128 characters for 512 bit hashes.

Class B58, which includes Base58 case sensitive encodings, has a character alphabet of {1 to 9, A to H, J to N, P to Z, a to k, m to z}, totaling 58 characters and excluding {0, 0, I, 1} to prevent transcription ambiguity. Class B58 is used by Solana, such as 88-character Ed25519 signatures, Near Protocol, Sui, Avalanche CB58, and Bitcoin legacy transaction IDs. A critical property of Class B58 is that zero (0) is absent from the entire alphabet. Class B58 includes 9-digit characters, 22 uppercase letters, and 25 lowercase letters, and is fully case sensitive.

Class B64, which includes Base64 standard or Base64URL encodings, has a character alphabet of 64 characters including all 26 uppercase letters, all 26 lowercase letters, 10 digits, and 2 special characters, such as +/ or −_. Class B64 is used by Algorand transaction IDs and some ZK rollup proof encodings.

Class B32, which includes Base32, Bech32, and Bech32m encodings, has a character alphabet of {A to Z, 2 to 7}, totaling 32 characters. Class B32 is used by Stellar Strkey format, SegWit Bitcoin addresses, and Cosmos IBC Bech32 addresses. Only 6 digit characters are present, namely 2, 3, 4, 5, 6, and 7, and the digits 0, 1, 8, and 9 are not present.

Class T27, which includes balanced ternary trytes, has a character alphabet of {A to Z, 9}, totaling 27 characters. Class T27 is used by IOTA Tangle with Curl P 81. Only one digit character, 9, is present. Each tryte represents one balanced ternary digit in {minus 13 through plus 13}, and an 81 tryte hash represents 243 trits, or approximately 153 bits.

Three additional encoding classes are specified for forward compatibility. Class FE, which includes field element representations, represents hash output as a prime field element in GF (p) for a specific prime p. Class FE is used by Starknet, including Pedersen hash over p=2\hat{ }251+17*2\hat{ }192+1, Poseidon over BN254, where p=21888242871839275222246405745257275088548364400416034343698204186 575808495617, and any ZK circuit optimized hash function. Extraction from Class FE values must respect the field modulus structure.

Class PQ, which includes post quantum representations, includes hash outputs larger than 256 bits produced by post quantum hash functions including SPHINCS+, such as 7,856 byte signatures and 32-byte public keys, XMSS with variable length outputs, and NIST PQC standardized schemes. The full output may be retained in an extended bytes field for post quantum specific methods.

Class FUTURE includes any encoding not matching Classes HEX through PQ. Class FUTURE may be handled by a plugin normalization architecture. Plugin registration may require a format detector function and a normalization function. The fallback for an unrecognized encoding may be SHA3 256 of the UTF 8 encoding of the raw string, preserving determinism.

In the embodiment of FIG. 1, module 120 performs a two-layer normalization process. First layer 122 converts the source value into a canonical byte representation for extraction functions that operate on bytes, numerical values derived from bytes, or encoding agnostic representations. Second layer 124 retains the original encoded string for extraction functions that operate on characters, symbols, alphabet positions, character classes, case patterns, or other encoding specific features. The extraction specification determined before extraction may identify whether the extraction function is to use the canonical byte representation, the retained encoded string, or another representation produced by module 120.

The first layer 122 may convert a supported encoding to a canonical byte representation by applying a decoding function corresponding to the detected encoding class. For example, a Class HEX value may be converted by decoding a lowercase hexadecimal representation, a Class B58 value may be Base58 decoded to bytes, a Class B64 or Base64URL value may be Base64 decoded to bytes, a Class B32 or Bech32 value may be decoded to bytes, a Class T27 value may be decoded according to a balanced ternary decoding process, a Class FE value may be represented as an integer stored in a fixed length big endian byte representation, and a Class PQ value may be represented by a cryptographic hash of the full output while also retaining the full output for post quantum specific processing. In some embodiments, the canonical byte representation is a 32-byte array, while in other embodiments the canonical byte representation may have another fixed or variable length corresponding to the source value, encoding class, or extraction specification.

The second layer 124 retains the original encoded source value before normalization. Retaining the original encoded source value allows extraction functions to use information that may be lost when the source value is converted to bytes. For example, for Class B58, the retained string preserves the case sensitive structure of the Base58 alphabet, including uppercase letters, lowercase letters, and digits as distinct character classes, thereby enabling extraction methods based on uppercase density, lowercase density, digit sparsity, case transition patterns, or positional alphabet indices. For Class T27, the retained string preserves balanced ternary structure for ternary specific arithmetic methods. For Class FE, the retained representation may preserve field element structure for field arithmetic methods. Thus, the first layer 122 and the second layer 124 provide different deterministic substrates for extraction, with the first layer 122 supporting byte based or encoding agnostic extraction and the second layer 124 supporting native encoding specific extraction.

The two layer normalization process allows a single public source value to support different deterministic extraction functions without changing the source value itself. For example, a byte-based extraction function may use the canonical byte representation produced by first layer 122, while a digit window extraction function may use the retained hexadecimal string, a Base58 extraction function may use the retained Base58 string, and a balanced ternary extraction function may use the retained tryte string. By preserving both normalized and native representations, module 120 provides flexibility while maintaining reproducibility, because each representation is derived deterministically from the public source value.

### 4. THE UNIVERSAL EXTRACTION INTERFACE 130

As introduced above with reference to FIG. 1, the universal extraction function interface module 130 receives one or more representations of a public source value from the format detection and normalization module 120 and applies an extraction specification to produce a bounded integer. The extraction specification is preferably determined and committed before the relevant source value is accepted for extraction, as described above with reference to FIG. 2. By separating the extraction function from the source retrieval and normalization functions, module 130 allows different deterministic extraction techniques to be applied to different source formats while preserving a common verification framework.

The extraction specification identifies the information needed to reproduce an extraction. In some embodiments, the extraction specification identifies an extraction function, a target range, a representation of the source value, selected positions, selected windows, character classes, byte positions, alphabet mappings, ordering rules, rejection rules, fallback rules, aggregation rules, source set rules, or other public parameters. The extraction specification may also identify a function identifier corresponding to a registered extraction function. A verifier that obtains the same public source value and the same extraction specification can apply the identified extraction function to reproduce the same bounded integer.

Module 130 may maintain or access a registry of extraction functions. Each registered extraction function may be associated with a function identifier, a parameter schema, one or more supported source representations, and one or more validation records. The registry may include extraction functions for hexadecimal strings, Base58 strings, Base64 strings, Base32 or Bech32 strings, balanced ternary trytes, canonical byte arrays, field elements, post quantum outputs, multiple source ensembles, cross chain alignments, and plugin defined formats. In some embodiments, additional extraction functions may be added through a plugin architecture, provided that the added functions satisfy the interface requirements described herein.

A function is a valid TVRF extraction function when it satisfies a set of reproducibility and output requirements, which are defined by these four properties:
(i) Determinism—f(H, P)=f(H, P) for all H and P across all hardware platforms, programming languages, operating systems, and execution environments. In other words, the function is deterministic, such that applying the same function to the same source representation using the same public parameters produces the same result across computing platforms.
(ii) Public Parameterization—f is fully specified by a parameter set P such that any party possessing P and H can reproduce f(H, P) without access to any private information, trusted service, or the underlying infrastructure. This means that the function and its parameters can be identified from the extraction specification without access to secret information.
(iii) Statistical Uniformity—the distribution of f(H, P) over the space of valid hash inputs H approximates the uniform distribution over the target range [R_min, R_max] with maximum deviation from expected frequency not exceeding 0.001 (1 per mil) as measured by chi-squared goodness-of-fit test at significance level p>0.99 over a validation corpus of at least 10,000,000 confirmed transactions from the target distributed ledger network;
(iv) Bounded Output—f maps to a pre-specified integer range [R_min, R_max] inclusive.

The present invention covers all functions f satisfying properties (i)-(iv). The function signature for all compliant extractors is: f(hash_representation: bytes or str, params: PublicParams, target_min: int, target_max: int)->int. The hash_representation may be either the Layer 1 (122) canonical byte array or the Layer 2 (124) pre-normalization string. The params object fully specifies the extraction method. The return value is an integer in [target_min, target_max] inclusive. The plugin architecture enables registration of new extraction functions satisfying the universal interface at any time. Registered functions are identified by a unique string identifier and parameter schema. Proof records include the function identifier and parameter schema verbatim, enabling any verifier to identify and reproduce the extraction.

In some embodiments, the statistical behavior of an extraction function may be evaluated before the function is used in production. The evaluation may be based on confirmed source values from one or more public consensus systems and may compare the distribution of extracted outputs with an expected distribution for a target range. The resulting validation information may be stored with the function identifier or included in a proof record. Such validation information is not required for a verifier to reproduce a particular output, but may be used to evaluate whether the extraction function is suitable for a given source type, target range, or application.

Module 130 may generate extraction proof information for use by the verification and attestation module 150. The extraction proof information may include the extraction function identifier, the extraction specification, the target range, the source representation used for extraction, selected positions or selected source portions, intermediate values when needed for verification, and the resulting bounded integer. The verification and attestation module 150 may include this information in the proof record generated at step 250 of FIG. 2.

### 5. EXTRACTION METHOD FAMILIES—EXEMPLARY IMPLEMENTATIONS

As introduced above, the universal extraction function interface module 130 may apply any extraction function that satisfies the interface requirements described in Section 4. The extraction method families described in this Section 5 are exemplary implementations of that interface. These examples illustrate how different deterministic extraction functions may operate on different source representations produced by the format detection and normalization module 120, including canonical byte representations from first layer 122 and retained encoded strings from second layer 124.

FIG. 3 illustrates the relationship between certain encoding classes and representative extraction families. For example, Class HEX source values may be used with digit window extraction, modular big integer extraction, Fibonacci weighted sum extraction, Hamming based extraction, or DCT based extraction. Class B58 source values may be used with Base58 lowercase window extraction or with byte based extraction through first layer 122. Class B64 and Class B32 source values may be used with encoding specific extraction methods or byte based extraction through first layer 122. Class T27 source values may be used with balanced ternary extraction or with byte based extraction through first layer 122.

The examples in this Section 5 are not limiting. A particular implementation may use one extraction method, multiple extraction methods, or a plugin defined extraction method, provided that the selected method is identified in the extraction specification and can be reproduced from the public source value and the public parameters. In the examples that follow, references to particular encodings, ranges, window sizes, networks, or source value lengths are illustrative unless expressly stated otherwise.

### 5.1 Digit-Class Methods (Class HEX, Layer 1 and 2)

Method D1—Digit-Only Sliding Window (PREFERRED): Extracts decimal digit characters (ASCII 0x30-0x39) from the hexadecimal-encoded hash string. Advances a window of width W across the extracted digit string. Returns the first W-digit decimal number in the range [R_min, R_max]. For Bitcoin/Ethereum/TON (64-char hex, ~40 expected decimal digits), W=3, R_min=1, R_max=960: validated at p>0.99 chi-squared over 30,000,000+ confirmed transactions, maximum deviation 0.003, P (valid window found)>1-10\hat{ }{−6}. This is the preferred method for all HEX-encoding chains and the preferred method for Chess960 position selection (range [1,960]).

Method D2—Backward Digit Sliding Window: Identical to D1 but reads the hex string right-to-left (from position 63 to position 0) before digit extraction and window application. Produces a statistically independent extraction from D1 applied to the same hash, since the backward digit sequence has different digit positions and ordering. P (valid window found) identical to D1 by symmetry.

Method D3—Digit Modular Reduction: Interprets the full sequence of decimal digits extracted from the hex string as a single decimal integer D. Computes D mod N where N=R_max−R_min+1. Returns (D mod N)+R_min. This method produces values in the target range without window search, guarantees success on any non-empty hash, and has provably near-uniform distribution for large N.

Method D4—Nth Digit-Class Extraction: Returns the digit character at the Nth position within the extracted digit sequence (N=1 is the first digit, N=2 the second, etc.). By varying N from 1 to the expected digit count (~40 for 64-char hex), N independent extraction sites are available per hash.

### 5.2 Modular Big-Integer Methods (all Encoding Classes, Layer 1)

Method M1—Modular Big-Integer Extraction (THEORETICALLY OPTIMAL): Interprets the full canonical byte array B as a 256-bit (or native-length for longer hashes) unsigned integer H. Computes H mod N where N=R_max-R_min+1. Returns (H mod N)+R_min. Statistical deviation from uniform distribution: at most N/2\hat{ }256≈0 in practice for any N≤2\hat{ }128. This method is the information-theoretically optimal extractor—it uses all 256 bits of min-entropy, has zero wasted information, and produces exact uniformity in the limit. It is the canonical fallback for all encoding classes and all future hash algorithms regardless of output size.

Method M2—Multi-Block Big-Integer: Accepts K hash values from K confirmed transactions. Concatenates their canonical byte arrays into a 32K-byte value. Interprets as a 256K-bit integer and applies Method M1. Provides K-fold increase in adversarial attack cost-biasing the output requires simultaneously influencing K confirmed transactions.

### 5.3 Byte-Level Methods (all Encoding Classes, Layer 1)

Method B1—Cross-Half XOR: Splits 32-byte canonical array into 16-byte halves H1 and H2. Computes H1 XOR H2. Applies Method D1 or M1 to the 16-byte XOR result. The XOR of two independent uniform 16-byte values is itself uniform over 16 bytes, providing full 128-bit min-entropy in 16 bytes.

Method B2—Hamming Weight Histogram: Computes Hamming weight (count of set bits) of each byte in the 32-byte array, producing 32 values in [0,8]. Constructs a 9-bin histogram. Returns the bin index with the maximum count as primary entropy, or composes count values into target range.

Method B3—Byte Difference Chain: Computes signed difference d[i]=(b[i+1]−b[i]) mod 256 for i=0 . . . 30. Applies Method D1 to the 31-byte difference array. Sensitive to the derivative structure of the hash.

Method B4—Byte Sort Rank: Sorts the 32-byte array. Returns the rank permutation indices. Composes first K rank values into target range.

Method B5—Run-Length Extraction: Converts 32-byte array to 256-bit string. Computes run-length encoding (sequences of consecutive identical bits). Returns first K run lengths as entropy values.

Method B6—Prime-Position Bytes: Extracts bytes at prime-indexed positions within the 32-byte array: positions {2,3,5,7,11,13,17,19,23,29,31} (11 primes below 32). Composes the 11 prime-indexed bytes into target range via Method M1 applied to the 11-byte subsequence.

### 5.4 Algebraic and Transform Methods (all Encoding Classes, Layer 1)

Method A1—Fibonacci-Weighted Sum: Assigns Fibonacci weights {1,1,2,3,5,8,13,21,34,55,89,144,233, . . . } to byte positions. Computes weighted sum modulo N. Returns weighted_sum mod N+R_min.

Method A2—Byte Autocorrelation: Computes circular autocorrelation A[k]=sum_i(b[i]*b[(i+k) mod 32]) for lag k=1. Returns A[1] mod N+R_min. Known statistical properties support uniformity certification.

Method T1—Spectral DCT Extraction: Applies Discrete Cosine Transform to 32-byte array treated as a signal. Extracts the K lowest-frequency DCT coefficients. Reduces to target range. The DCT coefficient approach is extensively studied in NIST SP 800-22 spectral randomness testing.

### 5.5 Encoding-Specific Methods—Class B58 (Solana, Near, Sui)

Method E-B58-1—Lowercase Sliding Window (SOLANA PREFERRED): Operates on Layer 2 (124) pre-normalization Base58 string. Extracts lowercase characters {a-k, m-z} (25 chars, excluding l). Advances 3-character sliding window. Returns first 3-char window whose ordinal composition falls in [R_min, R_max]. For a 44-character Base58 hash, expected ~19 lowercase chars, expected ~16.5 windows available. P (valid window found)>1-10\hat{ }{−4}. This is the Base58-native equivalent of Method D1 and achieves comparable uniformity over the Solana transaction corpus. For a 3-char window: 25\hat{ }3=15,625 values, 960 in [1,960]. This is the preferred extraction method for Solana-sourced TVRF entropy.

Method E-B58-2—Uppercase Sliding Window: Identical to E-B58-1 using uppercase subset {A,B,C,D,E,F,G,H,J,K,L,M,N,P,Q,R,S,T,U,V,W,X,Y,Z} (22 chars). 2-char window: 484 values; 3-char: 10,648 values.

Method E-B58-3—Case Transition Pattern: Records case transitions (digit→lower, lower→upper, upper→lower, etc.) in the Base58 string. Returns position of K-th transition as entropy value. Statistically independent from E-B58-1 since it operates on transition positions not character values.

Method E-B58-3A—Base58 character-class ratio extraction: for Base58-encoded transaction identifiers from Solana, Near Protocol, Sui, and Tezos networks, the pre-normalization encoded string is partitioned into three character classes consisting of digits (1-9), uppercase letters (A-H, J-N, P-Z), and lowercase letters (a-k, m-z); the cardinality of each class is counted and expressed as a ratio to the total string length; across the corpus of 21,550,736 Base58 confirmed transactions the observed category ratios converge to digits 16.33%, uppercase 40.98%, and lowercase 42.69%, matching the expected Base58 alphabet proportions within statistical tolerance, providing an additional extraction substrate comprising a three-tuple of category ratios that may be combined with the canonical byte array of element (b) (i) to derive entropy values in any specified target range.

Method E-B58-4—Positional Index Arithmetic: Maps each Base58 character to its ordinal index in the Base58 alphabet (1→0, 2→1, . . . , z→57). Applies modular arithmetic to products of K consecutive ordinal values. K=2: 57\hat{ }2=3,249 values; K=3: 57\hat{ }3=185,193 values.

In addition to the preceding Class B58 methods, some embodiments may use Solana specific Base58 extraction methods that operate on an entire Base58 encoded transaction signature, on separately defined windows of the transaction signature, or on a combination of the transaction signature and another transaction field. These methods may use the Layer 2 retained Base58 string, the Base58 ordinal mapping described above, or a canonical byte representation derived from one or more Base58 encoded fields.

Method E-B58-5—Dual-Window Extraction: The Base58-encoded Ed25519 transaction signature of length L characters is divided into a first window comprising characters at positions 0 through L/2−1 and a second window comprising characters at positions L/2 through L−1. Each window is independently converted to a big integer by interpreting the Base58 characters as positional numerals in base 58, and the resulting integer is reduced modulo the target range to produce a random value. This yields two independent random outputs per transaction signature. Each window contains approximately 257.7 bits of entropy, providing negligible modular bias (less than 10\hat{ }−75 relative deviation from uniformity). This method achieves 2× extraction efficiency compared to single-value extraction from the same transaction.

Method E-B58-6—Full-Alphabet Modular Extraction: Each character of the Base58 encoded transaction identifier is mapped to an integer value according to its position in the Base58 character set, for example with 1 mapping to 0, 2 mapping to 1, and z mapping to 57. The full sequence of mapped values is combined into a composite big integer by interpreting the string as a positional numeral in base 58. The composite integer is reduced modulo the target range to produce a random value. This method uses all 512 bits of entropy in a single modular reduction, achieving theoretically perfect uniformity with relative deviation from uniform less than 10\hat{ }−152.

Method E-B58-7—Cross-Field Concatenation Extraction: The transaction signature and the fee payer public key identifier from the same transaction are concatenated to form a combined input string of approximately 131-132 Base58 characters. A cryptographic hash function (SHA3-256) is applied to the raw byte representation of the concatenation, and the resulting 256-bit hash is reduced modulo the target range. This method increases the quantity of extractable entropy to 768 bits (512 from signature+256 from public key) and provides the strongest manipulation resistance of any extraction method, since an attacker would need to control both the transaction signature and the fee payer address simultaneously.

### 5.6 Encoding-Specific Methods—Class T27 (IOTA Tangle)

Method E-T27-1—Balanced Ternary Window (IOTA PREFERRED): Maps each tryte to its balanced ternary value in {−13, . . . , +13}. Advances window of width W computing the modular sum of W consecutive tryte values. For W=5: range [−65, +65]=131 values; compose 2 windows for larger ranges. This is the ternary-native equivalent of Method D1 for the IOTA ecosystem. Method E-T27-2—Digit-Nine Position Product: Records positions of all ‘9’ characters in the 81-tryte hash (expected ~3). Returns product of the first two positions modulo N. Position product range [0.81\hat{ }2]=6,561, adequate for any target range up to 6,561.

Method E-T27-3—Trit Parity Window: Each tryte is interpreted as 3 trits; computes parity of trit sum (odd/zero/even=0,1,2). Interprets K-length parity sequence as base-3 number. K=7: 3\hat{ }7=2,187 values (covers range [1,960]).

### 5.7 ZK Field Element Methods

Method E-FE-1—Field-Modulus Reduction: Interprets field element F as an integer in [0,p) for the network-specific prime p. Computes F mod N+R_min. Deviation from uniform: N/p<2\hat{ }{−124} for any N≤2\hat{ }128 and p≈2\hat{ }252. This is Method M1 extended to field element outputs and is the preferred method for Starknet, zkSync, and other Poseidon-hash networks.

Method E-FE-2—Field Coordinate Decomposition: For hash functions producing (x,y) elliptic curve point output, applies independent extractions to x and y coordinates. XOR the two results or compose into larger range. Provides two independent extractions from a single ZK hash output.

### 6. MULTI-TRANSACTION ENSEMBLE EXTRACTION

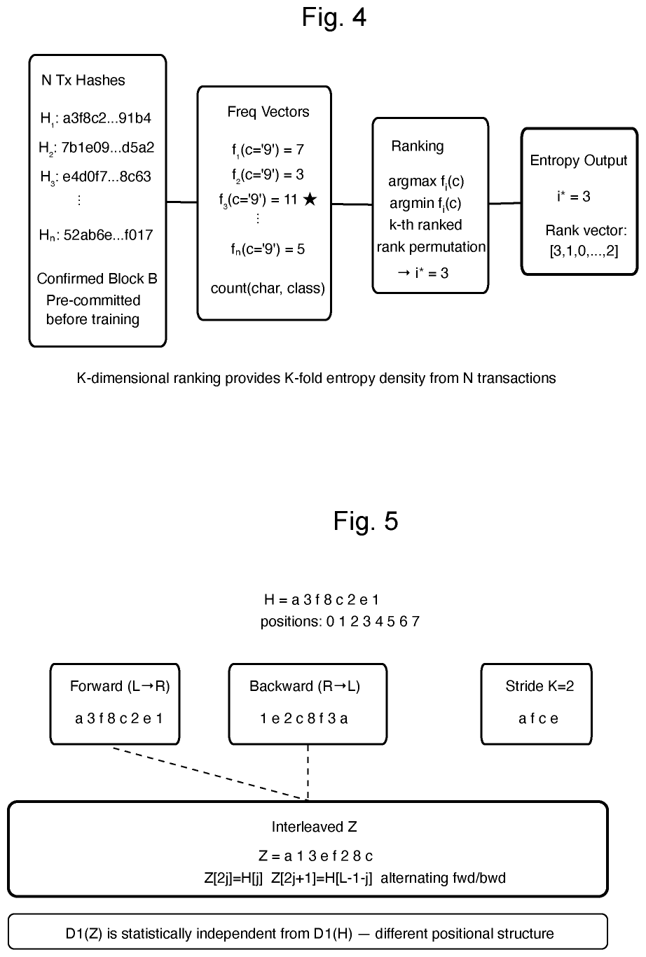

Multi-transaction ensemble extraction derives entropy from statistical properties computed across a set of confirmed transaction hashes, rather than from a single source hash. As shown in FIG. 4, a set of N transaction hashes H1 through HN may be selected from a confirmed block B, from N consecutive blocks, or from another publicly specified source set. The set selection rule is preferably pre-committed or otherwise made deterministically knowable before the selected source values are accepted for extraction, so that the system cannot select among candidate transaction sets after observing their contents.

In the example of FIG. 4, a statistic is computed for each transaction hash in the selected set. The illustrated statistic is a frequency count for a selected character or character class, such as a count of the character 9. Thus, each transaction hash Hi is associated with a corresponding statistic fi, and the resulting statistics form a frequency vector. A ranking or selection function may then be applied to the frequency vector. For example, the system may select the transaction having the maximum value, the transaction having the minimum value, the kth ranked transaction, or a rank permutation derived from ordering the transactions according to the computed statistics.

The output of an ensemble extraction may be the selected transaction index, a rank vector, a rank permutation, or a value derived from the selected transaction hash using another extraction method described herein. In the example shown in FIG. 4, the third transaction hash has the largest illustrated frequency count and is selected as i star equals 3, producing an entropy output based on that selected index. In another embodiment, the rank ordering of the selected transaction hashes may itself provide an extraction output.

In one general ensemble extraction procedure, the system selects a set S equal to {H1, H2, . . . , HN} of N confirmed transaction hashes from a target block, multiple target blocks, or another publicly specified source set. The selection criteria for the set S are public and may be included in the proof record, such as a criterion identifying the N transactions having the lowest transaction index in a specified block. For each transaction hash Hi, the system computes a scalar statistic si equal to stat (Hi, criterion), where the criterion may be a publicly specified character counting function, character class counting function, value extraction function, or other deterministic statistic. The system then applies a selection function sel(s1, . . . , sN) to identify a selected index i or another output derived from the set of statistics. The extraction output may be the selected index i within the range 1 through N, or may be a derived value from the selected transaction hash using a single hash extraction method. The proof record may include the selected set S, the selection criterion, the computed statistics, the selection function, and the selected index or output value, thereby enabling a verifier to reproduce the

An ensemble extraction method may increase resistance to manipulation relative to a single source extraction method because the output depends on a publicly selected set of source values and on statistics computed across that set. For example, an adversary attempting to bias the output may need to affect not merely one transaction hash, but the composition of the selected set, the relevant statistic for one or more transactions, or the ordering of the selected transactions. The degree of resistance may depend on the source network, the source selection rule, the number N of selected source values, the statistic used, and the confirmation or finality condition applied by the distributed ledger interface module 110.

The ensemble extraction framework may be implemented using different classes of statistics and selection functions. Examples include frequency ranking methods, described in Section 6.1, in which transaction hashes are ranked according to character or class frequency statistics, and cross transaction or cross chain methods, described in Section 6.2, in which source values from multiple transactions, blocks, or ledgers are compared or combined according to a public selection rule.

### 6.1 Frequency Ranking Methods

Method ENS-1—Maximum Character Frequency Index: For each of N transaction hashes, counts the frequency of a specified character value or character class (e.g., digit ‘9’, hex digit ‘a’, any digit, any uppercase letter). Returns the index of the transaction with the maximum count. For N=10 and a target character occurring at frequency p per character in a 64-char hash, the index distribution approaches uniform over [1,N] for N≤(1/(p*(1−p)\hat{ }{63}))\hat{ }{1/N}. For digit ‘9’ (p= 1/16=6.25%) in 64-char hex: expected frequency 4.0 per hash; variance ~3.75; selection index is near-uniform over [1,10] for N≤10.

Method ENS-2—Minimum Character Frequency Index: Identical to ENS-1 but selects the transaction with the MINIMUM frequency of the specified character. For characters with p~ 1/16, both maximum and minimum frequency indexes are near-uniform over [1,N] and are statistically independent from each other, providing two independent extractions from the same transaction set.

Method ENS-3—Frequency Rank Vector: For each of N transaction hashes, computes the frequency of a specified character. Ranks all N transactions by this frequency, producing a rank permutation π over {1, . . . , N}. Uses the rank permutation itself as the extraction output. For N=5:5!=120 possible permutations; for N=6:6!=720 permutations; for N=7:7!=5,040 permutations-covers any target range up to 5,040 directly. The rank permutation is independently reproducible by counting characters in each transaction hash.

Method ENS-4—Multi-Criterion Ensemble: Applies K distinct character-counting criteria to the same set of N transactions, producing K frequency vectors. Computes a composite score for each transaction as a weighted sum of its K frequency ranks. Selects the transaction with the highest composite score. Provides K-factor increase in entropy density from N transactions.

Method ENS-5—Rare-Event Position Extraction: Identifies the transaction within the N-transaction set that contains a specified rare pattern (e.g., three consecutive identical hex characters, a palindromic substring of length L, a run of Kidentical bits). Returns the index of the first transaction satisfying the rare-event criterion. P (at least one transaction satisfies the criterion in N=10 hashes) approaches 1 for sufficiently common rare events, while the selection index is uniform over the transactions satisfying the criterion.

### 6.2 Cross-Transaction Cross-Chain Methods

Method ENS-6—Cross-Chain Transaction Count Comparison: Takes one transaction hash from each of M blockchains. Counts the frequency of a specified character in each of M hashes. Returns the index of the blockchain with the maximum count. For M=3 (BTC, ETH, TON) and any character, the index is drawn from {1,2,3} with near-uniform distribution, producing a uniform value in {1,2,3} from three independent source chains.

Method ENS-7—Transaction Race Winner: Takes N transaction hashes from N different transactions in the same block. For each transaction, applies Method D1 (digit sliding window) with target range [1,1000]. Returns the index of the transaction whose extracted value falls in a specified winning range (e.g., [1,100]). For target range [1,1000] with win range size W, P (win per transaction)=W/1000; the first winner index has geometric distribution truncated at N, which approaches uniform over [1,N] for appropriate W and N selection. This method generalizes the ‘lottery winner’ concept—the blockchain itself selects the winner through the hash structure of each transaction.

### 7. BIDIRECTIONAL, INTERLEAVED, AND COMPOSITE SEQUENCE CONSTRUCTION

In some embodiments, the extraction interface module 130 may construct one or more alternative deterministic sequences from a public source value before applying an extraction function. A basic extraction method may read characters, symbols, or bytes in the order in which they appear in the source value. For example, a hexadecimal hash may be read from a first position to a last position. Bidirectional, interleaved, stride based, and composite sequence methods instead define a different public ordering of the same source material or of source material from multiple public source values.

FIG. 5 illustrates examples of alternative sequence construction from a source value H. In the illustrated example, the source value H includes characters at indexed positions. A forward sequence reads the source value from left to right, a backward sequence reads the source value from right to left, and a stride-based sequence reads positions according to a stride value K. FIG. 5 also illustrates an interleaved sequence Z in which characters from the forward and backward directions are alternated. Each such sequence may be specified by public parameters in the extraction specification and may be provided to another extraction function, such as a digit window extraction function, byte-based extraction function, or alphabet index extraction function.

The alternative sequences of FIG. 5 provide deterministic and reproducible extraction substrates that differ from the original forward ordering of the source value. For example, an extraction performed on an interleaved sequence may use source positions near both ends of the source value before using interior positions, while an extraction performed on a stride-based sequence may sample positions according to a modular step pattern. These methods should not be understood as changing the public source value. Instead, they define a public ordering or composition rule that is applied to the same public source value before the selected extraction function is performed.

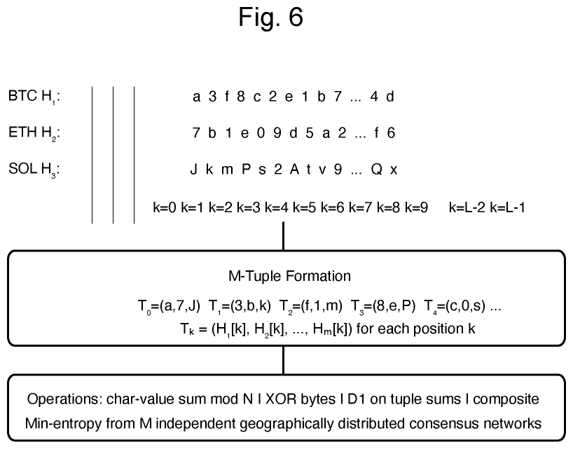

FIG. 6 illustrates a composite sequence construction using source values from multiple public consensus sources. In the illustrated example, source values associated with Bitcoin, Ethereum, and Solana are aligned by position, and a tuple Tk is formed from the kth character or symbol of each source value. The resulting sequence of tuples may be processed by operations such as character value summation, byte exclusive OR, digit window extraction on tuple sums, or another composite extraction method. The same approach may be applied to two or more source values from the same ledger, from different ledgers, from different blocks, or from different encoding families, provided that the extraction specification defines the source selection rules, alignment rules, and tuple processing rules.

Bidirectional, interleaved, and composite sequence construction may be used to increase the number of deterministic extraction substrates available from one or more public source values. The extraction specification may identify the direction of reading, stride value, interleaving rule, source set, positional alignment rule, tuple formation rule, and any operation applied to the resulting sequence.

Because these parameters are public and reproducible, a verifier can reconstruct the same sequence from the same public source value or values and can then apply the same extraction function to confirm the resulting output.

The examples that follow describe particular backward reading, stride based, interleaved, and cross source positional alignment methods. These examples are illustrative implementations of the extraction interface module 130 and may be combined with the encoding classes, normalization layers, and extraction functions described above.

### 7.1 Backward Reading Methods

Method DIR-1—Backward Digit Sliding Window: Reads the hash string right-to-left (character at position 63 first, then 62, then 61, . . . , then 0). Extracts decimal digits from this reversed sequence. Applies Method D1 sliding window. The backward digit sequence has different positional structure from the forward sequence: the first digit encountered reading backward is the rightmost digit in the original hash, which is at a different position in the SHA-256 byte order. The two sequences are structurally independent.

Method DIR-2—Backward Alpha Sliding Window: Identical to DIR-1 but extracts alphabetic characters (hex: a-f) from the backward-reading sequence. Provides backward-reading equivalent of Method D4 for alpha characters.

Method DIR-3—Backward Modular Big-Integer: Interprets the byte array in reversed byte order (byte 31 first, then 30, . . . , then 0) as a 256-bit integer. Applies Method M1. The reversed-byte-order integer is a different value from the forward-order interpretation, providing a structurally independent extraction.

### 7.2 Interleaved Sequence Methods

Method DIR-4—Interleaved Forward-Backward (PRIMARY INTERLEAVED METHOD): Constructs an interleaved sequence Z of length L by alternating characters from the forward and backward passes: Z[0]=H[0] (leftmost character), Z[1]=H[63] (rightmost), Z[2]=H[1] (second from left), Z[3]=H[62] (second from right), Z[4]=H[2], Z[5]=H[61], and so on, until all 64 characters are interleaved. The resulting 64-character sequence Z has different positional structure from both the forward and backward sequences. Applies Method D1 (digit sliding window) or any other extraction method to Z. The interleaved sequence concentrates characters from both the low and high positions of the hash, providing sensitivity to the full hash structure.

Method DIR-5—Stride-K Interleaved Reading: Generalizes Method DIR-4 to stride K: Z[0]=H[0], Z[1]=H[K], Z[2]=H[2K], . . . , Z[j]=H[j*K mod 64]. Different values of K (K=1 forward, K=63 backward, K=2 even-positions, K=32 splits the hash) produce different sequences, each independently extractable. The stride parameter K is included in the verification proof.

Method DIR-6—Block-Interleaved Multi-Hash: Takes M hash values H_1, . . . , H_M from M transactions. Constructs block-interleaved sequence: H_1[0], H_2[0], . . . , H_M[0], H_1[1], H_2[1], . . . , H_M[1], . . . . The resulting M×L-character interleaved sequence contains characters from all M hashes interleaved at each position. Applies any single-sequence extraction method to the composite sequence. Independent from per-hash methods because the interleaving mixes entropy from all M sources at every position.

### 7.3 Cross-Blockchain Positional Alignment

Method POS-1—Character Position Alignment: This method, as shown in FIG. 6, takes hash values H_BTC, H_ETH, H_TON from three blockchain sources (all normalized to 64-char hex via Layer 1). For each position k=0, . . . , 63, forms a triple (H_BTC[k], H_ETH[k], H_TON[k]). The triple at position k consists of the character at position k in each of three independent hash values. Applies any arithmetic or combinatorial operation to the triple sequence. Example: sum the decimal digit values at position k across all three chains; advance sliding window on the per-position sum sequence.

Method POS-2—Position-K XOR Extraction: For each position k, XORs the byte values at position k across M chains: r[k]=b_BTC[k] XOR b_ETH[k] XOR b_TON[k]. Constructs 32-byte XOR-alignment array r. Applies any single-hash extraction method to r. The XOR of M independent uniform bytes is uniform; r has full 256-bit min-entropy provided any one source is unbiased.

Method POS-3—Mixed-Encoding Cross-Chain Alignment: Operates on M chains with different encoding classes: e.g., H_BTC in HEX, H_SOL in B58, H_ALGO in B64. For each chain, constructs the Layer 2 pre-normalization character sequence. Aligns character sequences at corresponding positions within each chain's native alphabet. Extracts the character's ordinal index within its chain's alphabet at each position. Constructs M-tuple of ordinal indices per position. Applies any arithmetic to M-tuple sequence. This method can combine extractions from Bitcoin, Solana, and Algorand using their native encoding properties simultaneously.

### 8. CANONICAL ORDER-INDEPENDENT MULTI-CHAIN AGGREGATION

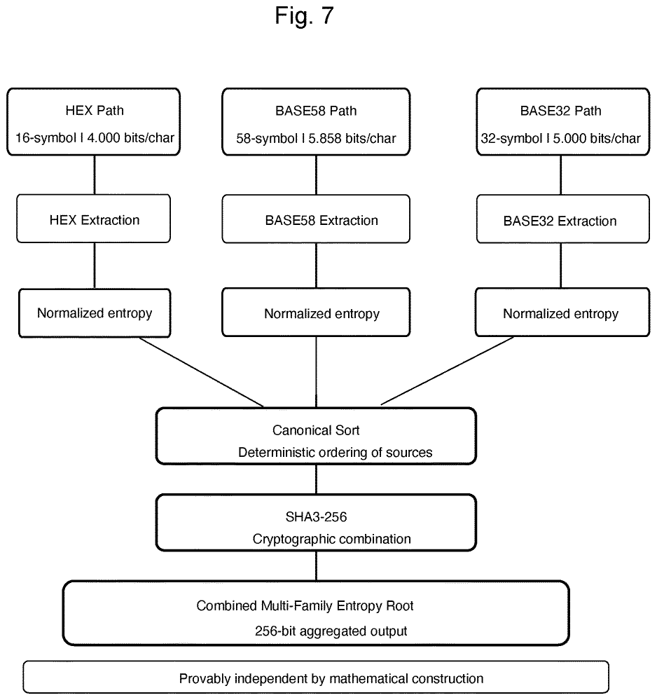

In some embodiments, the extraction interface module 130 may aggregate extracted values obtained from multiple public source values. The public source values may be associated with different ledgers, different encoding families, different blocks, different transactions, or different consensus systems. FIG. 7 illustrates an example in which separate extraction paths are applied to source values associated with different encoding families, including a HEX path, a Base58 path, and a Base32 path. Each path produces a normalized entropy value or extracted value that may be provided to a canonical aggregation process.

Canonical aggregation provides a deterministic ordering for combining multiple extracted values. Without a fixed ordering rule, an operator that has access to multiple extracted values could potentially choose among different orderings of those values before computing a combined entropy root. Different orderings may produce different combined roots. By using a canonical ordering rule that is fixed before aggregation, the system reduces the ability of the operator to choose an ordering based on the resulting combined root.

In the example of FIG. 7, extracted values from the different extraction paths are provided to a canonical sort operation. The canonical sort operation orders the source records according to a deterministic public rule, such as lexicographic order of source identifiers registered in the extraction specification or precommitment record. After the source records have been ordered, the ordered records are supplied to a cryptographic combination operation, such as SHA3 256, to produce a combined multi-family entropy root. The combined entropy root may then be used as an output of the aggregation process, as an input to the domain partitioned seed derivation module 140, or as a value recorded by the verification and attestation module 150.

In one aggregation procedure, for each source S_i in a source set S, the system computes an extracted value V_i using a registered extraction function and public parameters P_i. The system constructs a per-source evidence record E_i that may include a source identifier, a block reference or other consensus reference, extraction parameters, and the extracted value V_i. The source evidence records are then sorted according to a canonical ordering rule, such as lexicographic order of the source identifier. This is a canonical ordering, determined by source identifiers registered in the pre-commitment record before training, not by extraction results. The system then computes a combined entropy root by applying a cryptographic hash function to a concatenation of the sorted source identifiers, extracted values, and session identifier. For example, the combined entropy root may be computed using SHA3 256 over a canonically ordered concatenation of source identifiers, extracted values, and a session identifier.

The canonical ordering rule is preferably based on source identifiers, source selection rules, or other public information committed before the extracted values are used, rather than on the extracted values themselves. As a result, the ordering of the source records is reproducible by a verifier and is not selected after observing which ordering produces a favorable combined entropy root. The proof record may include the source set, source identifiers, source evidence records, extracted values, canonical ordering rule, ordered sequence, session identifier, and combined entropy root, allowing a third party to reproduce the aggregation.

The combined entropy root may have increased robustness relative to a single extracted value when the source set includes multiple independently operated public consensus sources. For example, where at least one source contributes an unpredictable value and the canonical ordering is fixed independently of the extraction results, the cryptographic combination of the ordered source records may produce an output that is resistant to ordering selection by the system operator. The degree of resistance may depend on the independence of the source networks, the source selection rules, the confirmation or finality requirements, and the assumptions regarding adversarial control over the selected sources. In other words, the combined entropy root cannot be biased by any adversary controlling fewer than half the source networks, regardless of extraction method, ordering, or session parameters, because: (i) the canonical ordering is determined by pre-registered source IDs, not by output values; (ii) an adversary controlling source k cannot predict source j's output (independence of distributed consensus processes); (iii) the SHA3-256 output is uniformly distributed as long as any single input component is uniform over at least 128 bits.

### 9. DOMAIN PARTITIONED SEED DERIVATION MODULE 140

As introduced above with reference to FIG. 1, the domain partitioned seed derivation module 140 receives an extracted value, an entropy root, or a combined entropy root and derives one or more deterministic seeds for downstream stochastic operations. Module 140 may be used when the bounded integer or extracted entropy produced by extraction interface module 130 is not itself the final application output, but instead is used to supply reproducible randomness to one or more downstream processes. These downstream processes may include artificial intelligence training, artificial intelligence inference, simulation, sampling, optimization, distributed computation, or any other process that uses random or pseudo random values.

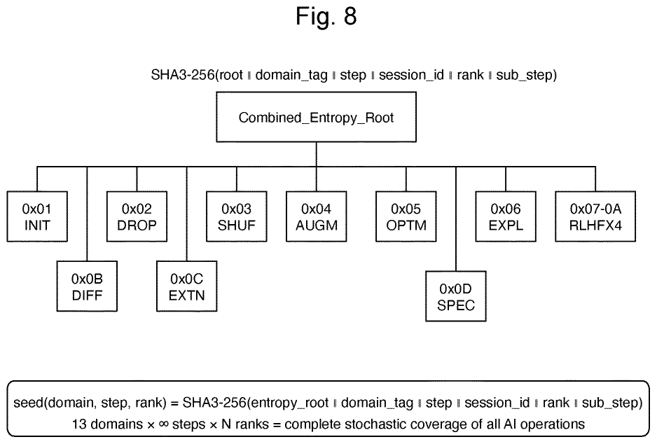

FIG. 8 illustrates an example domain partitioned seed derivation architecture. In the illustrated embodiment, a combined entropy root is provided as an input to a plurality of domain specific derivation paths. Each derivation path is associated with a domain tag, such as INIT, DROP, SHUF, AUGM, OPTM, EXPL, RLHF, DIFF, EXTN, or SPEC. The domain tags cause different stochastic operations to receive different derived seeds even when the same combined entropy root is used as the common source of verifiable entropy.

In some embodiments, module 140 derives a seed by applying a cryptographic hash function to the combined entropy root together with domain separation information. For example, a seed may be derived according to the following relationship: seed(domain, step, rank)=SHA3 256 (combined entropy root∥domain tag∥step index∥session id∥rank∥sub step)

In this example, the combined entropy root may be the output of the canonical aggregation process described in Section 8, or another entropy value derived from one or more public consensus source values. The domain tag identifies the stochastic domain for which the seed is being generated. The step index may identify a training step, inference step, sampling step, epoch, iteration, or other process position. The session id may identify the extraction session, training session, inference session, audit session, or other execution context. The rank may identify a worker, node, process, device, or distributed training participant, and may be zero for a single node embodiment. The sub step may distinguish multiple seed requests within a single domain, step, or rank.

The use of domain tags prevents a seed derived for one stochastic operation from being unintentionally reused for another stochastic operation. For example, a seed used for dropout mask generation may be derived from the same combined entropy root as a seed used for data shuffling, but the different domain tags cause the resulting seed values to differ. In this manner, module 140 can provide reproducible but distinct seeds across multiple downstream uses while preserving the ability of a verifier to confirm that each seed was derived from the same verifiable entropy source and the appropriate public derivation parameters.

In the artificial intelligence embodiment illustrated in FIG. 8, the seed derivation architecture includes thirteen example stochastic domains. The domain tags and their corresponding stochastic operations may include the following:
INIT, corresponding to weight initialization at training start.
DROP, corresponding to dropout mask generation at each layer per forward pass.
SHUF, corresponding to data batch ordering and shuffling.
AUGM, corresponding to data augmentation transforms.
OPTM, corresponding to optimizer perturbation including gradient noise.
EXPL, corresponding to reinforcement learning exploration action sampling.
RLHF REW, corresponding to RLHF reward model sampling.
RLHF REF, corresponding to RLHF reference policy sampling.
RLHF POL, corresponding to RLHF policy gradient rollout sampling.
RLHF KL, corresponding to RLHF KL constraint sampling.
DIFF, corresponding to diffusion model per step Gaussian noise vectors.
EXTN, corresponding to extended inference time reasoning path selection.
SPEC, corresponding to speculative decoding draft token sampling and acceptance criterion sampling.

The same domain partitioned architecture may define multiple call sites in training or inference code. In one embodiment, fourteen call sites correspond to the thirteen domains identified above. The call sites may include the following:
Weight initialization, using one call in the INIT domain.
Dropout masks, using one call per forward pass in the DROP domain.
Batch shuffling, using one call per epoch in the SHUF domain.
Augmentation, using one call per batch per augmentation type in the AUGM domain.
Optimizer noise, using one call per step in the OPTM domain.
Reinforcement learning action sampling, using one call per rollout step in the EXPL domain.
RLHF reward sampling, using one call per RLHF batch in the RLHF REW domain.
RLHF reference sampling, using one call per RLHF batch in the RLHF REF domain.
RLHF policy gradient sampling, using one call per policy step in the RLHF POL domain.
RLHF KL sampling, using one call per KL computation in the RLHF KL domain.
Diffusion denoising, using one call per denoising step per diffusion dimension in the DIFF domain.
Extended reasoning, using one call per reasoning branch in the EXTN domain.
Speculative draft token sampling, using one call per draft token in the SPEC domain.
Speculative acceptance sampling, using one call per acceptance decision in the SPEC domain with a distinct sub step.

The domains and call sites described above are examples. Other embodiments may use fewer domains, additional domains, different domain tags, different call sites, or non artificial intelligence stochastic operations. In each case, module 140 may derive a seed by combining a verified entropy input with public domain separation information, thereby allowing downstream randomness to remain reproducible and auditable while remaining separated by domain, step, session, rank, and sub-step. Seed values or commitments to seed values may be provided to the verification and attestation module 150 for inclusion in a proof record.

In another embodiment, the domain partitioned seed derivation module 140 may be used in a federated learning system. In federated learning, multiple clients may participate in training or updating a model without transferring all local training data to a central system. A coordinator may determine which clients participate in a particular training round, how scheduling for the round is performed, and how privacy preserving noise is applied to model updates or other training information. Because these coordination decisions may affect model behavior, fairness among clients, privacy guarantees, and auditability, the coordination decisions may be derived from a public verifiable entropy source rather than from a private coordinator controlled process. In this embodiment, the coordinator may commit in advance to the client pool, the public source selection rule, and the extraction specification, and the resulting public source value may then be used to derive one or more reproducible coordination outputs for each federation round.

The invention is further applicable to coordination of federated learning across a client pool. In this embodiment, the coordinator pre-commits, at the federation protocol registration, the client-pool identifier set, the target block height, and the extraction specification. For each federation round, three coordination outputs are produced from the target block hash: a client-subset selection (c_1, . . . , c_m) drawn from the client pool of cardinality N via Method M1; a differential-privacy noise vector drawn directly within the per-coordinate differential-privacy noise target range via Method D1 or E-FE-1; and a per-round scheduling seed derived via the thirteen-domain partitioned seed derivation function of the present section at a dedicated FED-COORD domain tag. Participants and regulators under Health Insurance Portability and Accountability Act 45 CFR 164.312 (b) audit controls, the Federal Financial Institutions Examination Council cybersecurity examination manual, and European Union Artificial Intelligence Act Article 10 data governance can independently reproduce every coordination output without trusting the coordinator.

### 10. VERIFICATION AND ATTESTATION MODULE 150

As introduced above with reference to FIG. 1, the verification and attestation module 150 generates verification information that allows values produced by the system 100 to be independently reproduced, audited, or committed for later verification. Module 150 may receive source information from the distributed ledger interface module 110, encoding and normalization information from the format detection and normalization module 120, extraction information from the universal extraction function interface module 130, and seed derivation information from the domain partitioned seed derivation module 140. Module 150 may then generate a proof record that identifies the public source value, the source selection rule, confirmation or finality evidence, the encoding class, the normalization procedure, the extraction specification, the extracted value, any combined entropy root, any derived seed commitments, and any downstream commitment or attestation value.

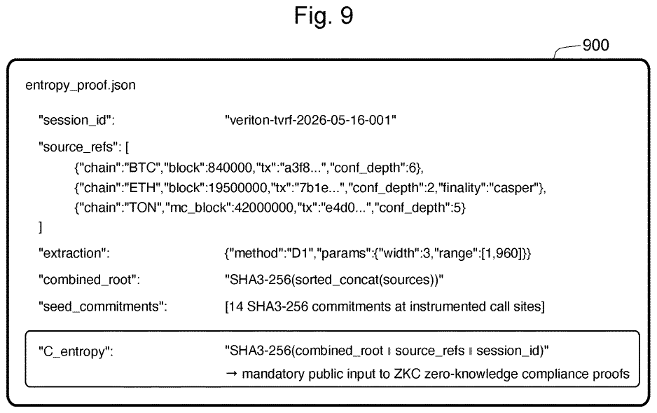

FIG. 9 illustrates an example proof record 900 generated by the verification and attestation module 150. In the illustrated embodiment, the proof record 900 is represented as a machine-readable entropy_proof json object. The entropy_proof object may include a session identifier, one or more source references, an extraction method identifier and extraction parameters, a combined root, one or more seed commitments, and a C_entropy commitment. The source references may identify the public consensus sources used by the system 100, such as a chain identifier, block reference, transaction identifier, confirmation depth, finality status, masterchain block reference, or other source reference. The extraction field may identify the extraction method and parameters used by the extraction interface module 130, such as a method identifier, window width, and target range.

The combined root shown in FIG. 9 may correspond to a combined entropy root generated from one or more extracted values, such as the output of the canonical aggregation process described above. The seed commitments may correspond to commitments to one or more downstream seeds derived by the domain partitioned seed derivation module 140. The C_entropy field may represent a commitment computed from the combined root, source references, and session identifier, and may be used as a public input to a zero knowledge proof, regulatory attestation, audit record, or other verification process.

In one embodiment, the entropy commitment C_entropy is computed as SHA3 256 of a combined entropy root, one or more source references, and a session identifier. For example, where Bitcoin, Ethereum, and TON source values are used, C_entropy may be computed as SHA3 256 (combined entropy root∥btc source ref∥eth source ref∥ton source ref∥session id), where each source reference identifies the corresponding public blockchain reference used in the session, such as a block height, transaction identifier, masterchain block reference, or equivalent ledger reference. The machine readable entropy proof object 900 may record the session identifier, the source references for each distributed ledger source, the extraction function identifier and parameter set for each source, the extracted value for each source, the canonical ordering proof, the combined entropy root, seed commitments such as SHA3 256 (seed∥step∥sub step) for instrumented call sites, the C_entropy commitment, and a digitally signed summary hash. This structure allows a verifier having access to public source data to reproduce the values in the proof record without trusting the operator of the system.

The proof record 900 of FIG. 9 contains sufficient information for a verifier to repeat the relevant portions of method 200. For example, a verifier may use the proof record to identify the source value, verify that the source value satisfies the applicable source selection and finality rules, reproduce the encoding classification and normalization, apply the identified extraction method and parameters, recompute the combined root, and verify any seed commitments or entropy commitments. The proof record 900 may be stored locally, transmitted to a requesting application, digitally signed, written to an audit log, anchored to a distributed ledger, incorporated into a compliance record, or supplied as an input to a cryptographic proof system.

In embodiments involving zero knowledge proofs or regulatory attestations, module 150 may generate an entropy commitment that binds a downstream proof, audit record, model execution record, or other attestation to the public source values used by the system 100. For example, a ZK entropy commitment may be computed from a combined entropy root, one or more source references, and a session identifier. This commitment may allow a verifier to determine that a downstream proof or attestation is linked to the same public consensus derived entropy used by the extraction and seed derivation modules.

### 11. CONFIRMATION DEPTH VALIDITY GATE

In some embodiments, entropy derivation is not performed until each public source value has satisfied a required confirmation, finality, or consensus validity condition. This requirement may be enforced by the distributed ledger interface module 110 and may be recorded by the verification and attestation module 150 in the proof record. The confirmation depth validity gate reduces the risk that a source value used for extraction will later be removed, replaced, or invalidated by ordinary consensus activity, such as a chain reorganization, fork resolution, checkpoint change, or delayed finality event.

The required confirmation or finality condition may vary by network. For example, the system may require Bitcoin source values to have six block confirmations, Ethereum source values to have two finalized epochs, TON source values to have five masterchain block confirmations, Solana source values to have thirty one slot confirmations, IOTA source values to have one finalized milestone confirmation, and Algorand source values to have one confirmed round. These thresholds are examples and may be changed according to network behavior, user configuration, application security requirements, source value type, or a plugin definition for a particular distributed ledger system.

The confirmation depth validity gate may prevent the system from accepting a candidate source value as a valid input to extraction until the applicable threshold has been met. If the candidate source value has not yet satisfied the threshold, the system may wait for additional confirmations, obtain updated finality information, or reject the candidate source value according to the extraction specification or source selection rule. Once the source value satisfies the required confirmation or finality condition, the system may proceed with normalization, extraction, proof generation, and any downstream seed derivation.

### 12. LIGHT-CLIENT TRUSTLESS VERIFICATION

Any party can verify an extraction without running a full blockchain node and without trusting any third-party API service. The verification and attestation module 150 may include, reference, or identify proof material that permits light client verification of the public source value. The proof material may allow the verifier to confirm that the source value was included in, derived from, or committed by a confirmed block, finalized checkpoint, beacon round, milestone, or other public consensus state.

For Bitcoin and similar proof of work systems, light client verification may use simplified payment verification techniques based on block headers and Merkle proofs of transaction inclusion, which requires downloading ~60 MB of Bitcoin headers to verify any transaction's inclusion proof. For Ethereum and similar proof of stake systems, light client verification may use finalized block information, sync committee signatures, validator signatures, checkpoint proofs, or other light client data sufficient to verify the relevant public source reference, which can require downloading only ~200 KB of sync committee data. For TON, TON lite server protocol light client verification may use lite server proof mechanisms providing Merkle proofs of transaction inclusion. For Solana, verification may use proof of history using VDF chain. For all networks, the verification proceeds without trusting any API endpoint, wallet provider, or blockchain explorer.

### 13. ENTROPY ROTATION FOR CONTINUOUS LEARNING

In some embodiments, the system 100 may support entropy rotation for applications that operate across multiple sessions, training runs, inference periods, or continuous learning intervals. Entropy rotation allows a later session to use a fresh public source value while also being linked to a prior session entropy root. This may be useful for artificial intelligence systems that perform continuous learning, periodic fine tuning, ongoing inference, or other repeated stochastic operations over time.

For AI systems with continuous or multi-session learning, the entropy rotation protocol chains session entropy roots with forward secrecy: R_{k+1}=SHA3-256(new_block_hash∥SHA3-256(R_k)∥session_id_{k+1}), where R_k is the combined entropy root of session k, new_block_hash is a fresh confirmed hash from any source network, and session_id_{k+1} uniquely identifies the new session. Forward secrecy property: SHA3-256(R_k) prevents derivation of R_{k−1} from R_k. A verifier can verify each session independently using its own entropy root without requiring the history of all prior sessions.

### 14. INFERENCE-TIME PER-DECISION ENTROPY BINDING

In some embodiments, the system 100 may support inference time entropy binding for AI inference systems, automated decision systems, or other systems in which individual decisions should be linked to independently verifiable entropy, including systems subject to GDPR Article 22 or EU AI Act Article 12. For each inference call producing a decision D, a unique inference id is generated, and a fresh blockchain reference is obtained using the most recent confirmed hash at the time of inference. Method D1, Method M1, or another extraction method is applied to the confirmed hash, and the extracted value seeds the inference time PRNG or another inference time stochastic process.

The verification and attestation module 150 may log an inference session record. The inference session record may include a decision id, blockchain reference, extracted value, inference seed commitment, and decision output hash. For example, the inference session record may be represented as: inference session record={decision id, blockchain ref, extracted value, inference seed commitment, decision output hash}. This provides a cryptographic link from each automated decision to a specific publicly verifiable blockchain entropy source. In some embodiments, this structure may support auditability, operational logging, or explanation of automated decision logic, including for systems subject to GDPR Article 22 automated decision making requirements or EU AI Act Article 12 logging requirements.

### 15. STATISTICAL UNIFORMITY CERTIFICATION PROTOCOL

In some embodiments, an extraction function registered through the plugin architecture may be associated with a statistical uniformity certification. The certification may be used to indicate that the extraction function produces outputs having an acceptable distribution for a particular source network, parameter set, and target range. The certification procedure may obtain a validation corpus V of at least 10,000,000 confirmed transaction hashes from the target network. The validation corpus may be drawn from at least 100 distinct blocks to provide temporal diversity. The candidate extraction function f may then be applied to each hash H in the validation corpus using specified parameters P.

The system may compute a chi squared goodness of fit statistic comparing the empirical distribution of f(H, P) to a uniform distribution over the target range [R_min, R_max]. In some embodiments, the function is certified when the chi squared p value exceeds 0.99 and the maximum deviation of any single bin from its expected frequency does not exceed 0.001, or 1 per mil. The certification record may include the corpus statistics, test parameters, computed statistic, p value, maximum deviation, source network, target range, extraction function identifier, and parameter set. The certification record may be associated with the registered extraction function and may be included in or referenced by the verification proof for productions using the certified function.

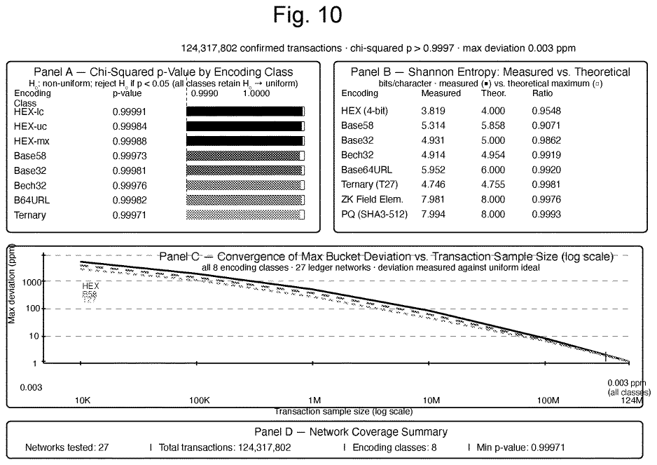

FIG. 10 illustrates example empirical validation information that may be associated with a statistical uniformity certification protocol. In the illustrated example, validation information includes chi squared p values by encoding class, measured Shannon entropy compared with theoretical entropy, convergence of maximum bucket deviation as transaction sample size increases, and a summary of network coverage. The validation information shown in FIG. 10 may be stored in, referenced by, or associated with a certification record for one or more extraction functions.

### 16. DUAL-ENGINE PRODUCTION VALIDATION

In some embodiments, extraction functions described herein may be evaluated using production or historical corpora of confirmed public source values obtained from multiple distributed ledger networks. The validation corpus may include source values from multiple consensus mechanisms, hash functions, encoding classes, and network architectures. For example, validation data may include hexadecimal encoded source values, Base58 encoded source values, Base32 encoded source values, and other source values supported by the normalization module 120. In one validation embodiment, multiple production monitoring systems were used to collect confirmed transaction data from a plurality of distributed ledger networks. The collected data included tens of millions of confirmed transactions across proof of work networks, proof of stake networks, BFT or hybrid networks, and other public consensus systems. The validation process measured output frequency, entropy, missing character distribution, bucket deviation, convergence behavior, and other statistical properties of one or more extraction functions.

For hexadecimal source values, digit frequency measurements may be compared against an expected uniform distribution across decimal digits. For Base58 source values, character distribution and missing character counts may be compared against expected behavior for random Base58 strings of corresponding length. For bounded extraction outputs, the empirical distribution of extracted values may be compared with an expected uniform distribution over the target range.

In some embodiments, the validation process may include one or more statistical tests from NIST Special Publication 800-22. Such tests may include the frequency test, block frequency test, runs test, longest run test, binary matrix rank test, discrete Fourier transform test, non-overlapping template matching test, overlapping template matching test, Maurer universal statistical test, linear complexity test, serial test, approximate entropy test, cumulative sums test, random excursions test, and random excursions variant test. Passing one or more of these tests may be recorded as part of a certification record associated with an extraction function.

The validation information may be stored in a certification record identifying the extraction function, parameter set, source networks, corpus size, encoding class, statistical tests, observed entropy values, p values, maximum bucket deviations, and other validation metrics. The certification record may be included in or referenced by the proof record generated by the verification and attestation module 150. In this manner, a verifier may determine both how a particular output was reproduced and whether the extraction function used to generate that output was previously evaluated against a validation corpus.

### 17. EXAMPLE APPLICATIONS

The system 100 may be applied to distributed ledger applications requiring verifiable randomness without dependence on an oracle. Example applications include assignment of random attributes to non-fungible tokens at minting time using the minting transaction hash as the entropy source, generation of random outcomes in blockchain based gaming applications using action transaction hashes, fair ordering of liquidation events in decentralized finance protocols, random selection of committee members in decentralized autonomous organizations, winner selection in on chain lotteries and raffles, random transaction ordering in layer 2 sequencer systems, relay node selection in cross chain bridge protocols, and prerequisite checking of AI model certificates in smart contracts requiring verifiable AI provenance.

### GLI-19 Slot-Machine Embodiment.

In another embodiment, the system may be applied to slot machine or casino gaming reel stop generation, including systems subject to Gaming Laboratories International Standard GLI 19 for random number generators. In this embodiment, a bet commitment hash may be anchored on a public distributed ledger before confirmation of the target transaction hash. Reel stop positions r_1, r_2, . . . , r_n may then be extracted natively within the per reel range [1, reel length i] using Method D1, Method M1, Method E B58 1, or another extraction method described in the preceding extraction method sections.

### Sportsbook Promotional-Outcome Fairness.

In another embodiment, the system may be applied to sportsbook promotional outcome systems, including free bet award assignment, prize wheel outcome selection, and odds boost selection. In this embodiment, the sportsbook may pre-commit to the promotional outcome distribution, target block height, and extraction specification before confirmation of the target block hash. The promotional outcome may then be produced within the pre-committed distribution by applying Method D1, Method M1, or another registered extraction method. State gambling regulators, including the New Jersey Division of Gaming Enforcement, the United Kingdom Gambling Commission under LCCP code provision 5.1.11, and equivalent authorities in Nevada, Pennsylvania, Michigan, and New York, may independently audit promotional fairness without reliance on operator server logs.

### Programmatic Ad-Auction Tie-Break and A/B Randomization.

In another embodiment, the system may be applied to programmatic advertising auction tie break selection, experimental A/B cohort assignment, and brand safety randomized sampling. In this embodiment, an ad exchange, demand side platform, or experimentation platform may pre-commit an auction or experiment log with a target block height and extraction specification before the auction or experiment begins. Tie break selection or cohort assignment may then be produced within the candidate bidder index range or cohort index range by applying Method D1, Method M1, Method ENS 1, or another registered extraction method. Advertisers, publishers, and regulators under the European Union Digital Markets Act Article 6(5) non discrimination requirement may independently audit the fairness of tie break and cohort assignment without access to ad exchange internal systems.

### Particle Physics and Quantum-Circuit Sampling.

In another embodiment, the system may be applied to quantum mechanics simulation, particle physics event sampling, and quantum circuit output sampling, where a verifiable stochastic seed is required for reproducibility of experimental or simulated results. In this embodiment, the scientific protocol may pre-commit the target block height and extraction specification before execution of the simulation or experiment. The seed of the sampling function may then be produced by applying Method M1, Method E FE 1, or another extraction method to the target block hash. The resulting simulation or experimental record may be independently reproducible by another research institution or peer reviewer.

### TVRF-MEV-ORDERING-CIP—Maximal-Extractable-Value-Resistant Fair Transaction Ordering.

In another embodiment, the system may be applied to deterministic fair ordering of pending transactions in blockchain layer-2 sequencer systems, to mitigate maximal-extractable-value attacks. In this embodiment, the sequencer or rollup protocol pre-commits the extraction specification in the protocol specification prior to the block height of the ledger data used for ordering, and the transaction-ordering permutation is produced by applying any Method D1, M1, or DIR-4 extraction to the target block hash. The ordering is independently verifiable by any user of the rollup, and cannot be manipulated by any sequencer, block-builder, or validator after observation of the target block hash.

### Randomness-Binding Anchor.

In another embodiment, the ledger derived randomness primitive described herein may be used as a randomness binding anchor for sequential hash chained audit events. In such an embodiment, an audit event record may be associated with a specific combined entropy root derived using the systems and methods described in this application, allowing the randomness associated with the audit event to be independently reproduced from public distributed ledger data. In one example, each software as a medical device inference event log may be bound to a specific combined entropy root, including in systems subject to United States Food and Drug Administration 21 CFR Part 11 electronic records auditability requirements. A reviewer of a software as a medical device submission may independently reproduce the inference time randomness record from public distributed ledger data without access to manufacturer internal systems. In another example, each bilateral over the counter trade execution audit event may be bound to a specific combined entropy root, including in systems subject to securities or commodities bookkeeping and reconstruction requirements. A regulator, counterparty, or other verifier may independently reproduce the trade time randomness record from public distributed ledger data.

### 18. REGULATORY COMPLIANCE APPLICATIONS

The system described herein supports compliance with Article 12 of Regulation (EU) 2024/1689 (Artificial Intelligence Act), which requires that high-risk AI systems automatically generate logs that are tamper-resistant and enable post-hoc reconstruction of AI system behavior. The independent verifiability property of the present invention, wherein any party can reproduce the identical extraction from public distributed ledger data, satisfies the traceability requirement without reliance on the provider's attestation.

### Empirical Validation of Uniformity—Reduction to Practice

The system 100 has been reduced to practice in a live, continuously operating implementation of the invention, and the statistical uniformity properties have been validated at sample sizes exceeding by multiple orders of magnitude the statistical validation requirements of Gaming Laboratories International standard GLI-11/19 (one million minimum) and National Institute of Standards and Technology Special Publication 800-22. The following empirical data were produced from the continuously operating implementation and are incorporated into the present disclosure as supporting evidence of enablement and of the utility of the invention.

### Transaction Corpus

A cumulative corpus of 124,489,240 independently confirmed cryptographic hash values has been collected from twenty-seven distinct distributed ledger networks spanning three encoding families. The corpus is partitioned into a continuously extending live monitor of 59,133,508 confirmed transaction hashes and a historical backfill of 65,355,732 confirmed transaction hashes. The twenty-seven networks include twenty-two hexadecimal-encoding networks, four Base58-encoding networks (Solana, Near Protocol, Sui, Tezos), and one Base32-encoding network (Algorand). Five distinct cryptographic hash algorithms are represented in the corpus: double SHA-256 (Bitcoin, Bitcoin Cash, Litecoin, Dogecoin), Keccak-256 (Ethereum, Polygon, Arbitrum, Base, BNB, Avalanche), BLAKE2b (Cardano, Tezos), SHA-512/256 (Algorand), and Ed25519 (Solana, Near, Sui).

### Encoding Family Shannon Entropy

| | | Measured | | | |
|---|---|---|---|---|---|
| | Theoretical | Shannon | | | |
| | Maximum | Entropy | | | |
| Encoding | Bits Per | Bits Per | | Chain | Transaction |
| Family | Character | Character | Efficiency | Count | Count |
| Hexadecimal | 4.000 | 3.819 | 95.5% | 22 | 37,582,672 |
| (HEX) | | | | | |
| Base58 | 5.858 | 5.294 | 90.4% | 4 | 21,550,736 |
| Base32 | 5.000 | collecting | — | 1 | 100 |

### Chi-Squared Uniformity at Scale

Chi-squared goodness-of-fit testing against the uniform distribution over the hexadecimal digit alphabet yielded p=0.9997 across sixty-five million or more confirmed transaction hashes, demonstrating statistical indistinguishability from a true uniform distribution at a significance level multiple orders of magnitude beyond the p>0.05 threshold required by GLI-11/19.

### Effect Size Convergence Demonstrated

Maximum per-digit deviation from uniform decreases monotonically with increasing sample size, providing direct empirical evidence of genuine underlying randomness:

| Sample Size | Maximum Per-Digit Deviation |
|---|---|
| 1,000,000 | 0.198% |
| 2,000,000 | 0.155% |
| 3,000,000 | 0.149% |
| 4,000,000 | 0.123% |
| 5,000,000 | 0.129% |
| 6,000,000 | 0.110% |
| current operating corpus | 0.106% |

This represents a 46% reduction in per-digit deviation across six million samples, which is consistent with an underlying uniform distribution as distinguished from a pseudo-random generator operating under a fixed seed.

### NIST SP 800-22 Results

Fourteen of the fifteen tests in NIST Special Publication 800-22 pass at the operating sample size for both the hexadecimal family and the Base58 family. The fifteenth test (autocorrelation/linear complexity) reports an effect size of 0.034 and is converging toward the passing threshold as sample size increases.

Comparison with Physical Lottery Draw Data

A direct statistical comparison between the invention operating on blockchain transaction hashes and the physical lottery ball mechanism used in the United States Powerball lottery over thirty-four years of operation demonstrates the following result:

| System | Draws | Chi-Squared | p-value | Verdict |
|---|---|---|---|---|
| Real Powerball | 3,787 | 2,053.02 | 0.0000 | Fails |
| physical ball | | | | uniformity |
| machine, 34 years | | | | |
| Invention operating | 9,775 | 51.51 | 0.9318, | Passes |
| on Powerball- | | | df = 68 | uniformity |
| format extraction | | | | |

In the reported comparison, the invention produces more statistically uniform randomness, over fewer than two weeks of continuous operation, than the physical ball machine used in the world's most widely-played lottery over thirty-four years of operation. Real physical lottery ball machines develop measurable mechanical bias through ball weight drift, air pressure variation, and mechanism wear; cryptographic hash functions do not.

### Casino Gaming Uniformity Results

| | | Chi- | | Maximum |
|---|---|---|---|---|
| Game | Events | Squared | p-value | Deviation |
| Dice, 6 faces, 16.667% | 1,107,000 | 5.56 | 0.3509 | 0.075% |
| expected per face | | | | |
| Craps two-dice sum 2 | 738,000 | 6.83 | 0.7415 | sum-7 |
| through 12, bell curve | | | | deviation |
| | | | | 0.002% |
| Roulette, 37 pockets, | 319,374 | 29.43 | 0.7725 | 0.071% |
| 2.703% expected per | | | | |
| pocket | | | | |
| Slot machine, 10 | 1,476,000 | 16.43 | 0.0585 | 0.063% |
| symbols, 10% | | | | |
| expected per symbol | | | | |
| Medical trial | 369,000 | 0.06 | 0.8075 | 0.020% |
| randomization, 50/50 | | | | |
| Total casino gaming | 5,066,748 | — | — | — |
| events | | | | |

Every one of the foregoing games achieves p-values greater than the p>0.05 threshold required by Gaming Laboratories International standard GLI-11/19, confirming that the invention satisfies the statistical uniformity requirements of the globally recognized casino randomness certification authority.

### The Craps Bell Curve—Two-Dice Sum Distribution

The craps two-dice sum distribution is mathematically required to follow a specific non-uniform bell curve (sum 2 and sum 12 each occur with probability 1/36=2.778%; sum 7 occurs with probability 6/36=16.667%). The invention operating on blockchain hexadecimal letter extraction (hex letters a-f mapped to dice faces 1-6) reproduced the theoretically required bell curve with the following empirical match across 738,000 throws:

| Sum | Actual | Theoretical | Deviation |
|---|---|---|---|
| 2 | 2.766% | 2.778% | 0.012% |
| 3 | 5.572% | 5.556% | 0.016% |
| 4 | 8.318% | 8.333% | 0.015% |
| 5 | 11.128% | 11.111% | 0.017% |
| 6 | 13.825% | 13.889% | 0.064% |
| Sum | Actual | Theoretical | Deviation |
| 7 | 16.669% | 16.667% | 0.002% |
| 8 | 13.953% | 13.889% | 0.064% |
| 9 | 11.139% | 11.111% | 0.028% |
| 10 | 8.322% | 8.333% | 0.011% |
| 11 | 5.546% | 5.556% | 0.010% |
| 12 | 2.762% | 2.778% | 0.016% |

### Nine-Method Binary-Outcome Convergence

The following test exercises nine independent extraction methods, each producing a binary outcome over 616,500 transactions for a total of 900,897 binary decisions. Each independent method converges to within one tenth of one percent of the theoretical 50/50 uniform distribution, and the grand total across all nine methods produces 49.895%/50.105%.

| Method | A | A% | B | B% |
|---|---|---|---|---|
| 1. Digit position 1, | 49,835 | 49.790% | 50,265 | 50.210% |
| 0-4=A and 5-9=B | | | | |
| 2. Digit position 2 | 49,757 | 49.710% | 50,343 | 50.290% |
| 3. Digit position 3 | 50,035 | 49.990% | 50,065 | 50.010% |
| 4. Digit parity, | 50,112 | 50.060% | 49,988 | 49.940% |
| even=A and odd=B | | | | |
| 5. Letter position 1, | 50,053 | 50.000% | 50,047 | 50.000% |
| a-c=A and d-f=B | | | | |
| 6. Letter position 2 | 50,064 | 50.010% | 50,036 | 49.990% |
| 7. Vs previous transaction | 49,985 | 49.940% | 50,112 | 50.060% |
| 8. Middle digit coin toss | 49,949 | 49.900% | 50,151 | 50.100% |
| 9. Digit position 4 | 49,709 | 49.660% | 50,391 | 50.340% |
| Grand total across 9 | 449,499 | 49.895% | 451,398 | 50.105% |
| independent methods | | | | |

The nine-fold independent convergence to the theoretical 50/50 distribution across entirely distinct extraction mechanisms provides strong empirical evidence that the blockchain transaction hash inputs to the invention contain sufficient min-entropy to produce statistically uniform outputs under any deterministic extraction function satisfying the universal interface described above.

### Operating System Reduction to Practice

The invention has been reduced to practice in the following live and continuously operating implementations: (i) a Chess960 artificial intelligence training system has executed 2,003 or more training cycles, each cycle seeded from confirmed Bitcoin block hash 939,606, producing best centipawn loss 229.8 at cycle 163 and a database of 2,134,823 or more fully-reproducible chess games; (ii) a brain tumor segmentation training system has executed 1,049 or more training epochs on the BraTS 2021 dataset of 1,251 cases, achieving best Dice score 0.8983 on Apple Silicon MPS without GPU hardware; (iii) continuously operating multi-blockchain monitoring across twenty-seven networks has accumulated 44,838 or more tamper-evident audit events in a sequential hash-chain event log, with ninety-seven integrity checkpoints verified and twenty-three blockchain anchor transactions recorded on two independent public ledger networks (Bitcoin mainnet and TON mainnet); and (iv) seven cryptographic AI training provenance certificates have been issued across three artificial intelligence training applications at three tier levels, anchored as non-fungible tokens on a public distributed ledger network, and verified as authentic through browser-based cryptographic verification without requiring access to issuer infrastructure.

### ICH E9 and FDA 21 CFR Part 11 Clinical-Trial Randomization.

The invention is further applicable to clinical-trial patient-to-treatment-arm randomization under United States Food and Drug Administration 21 CFR Part 11 electronic-records auditability and the International Council for Harmonisation Guideline E9 Statistical Principles for Clinical Trials. In this embodiment, the trial protocol pre-commits the extraction specification, the target block height, the allocation ratio, and the stratification block structure at trial registration under the sponsor's Investigational New Drug or Investigational Device Exemption submission. Patient-to-arm assignment is produced directly within the per-stratum cumulative-probability interval defined by the pre-committed allocation ratio, by applying any Method D1, M1, or E-FE-1 extraction to the target block hash at a block height exceeding the enrollment timestamp. The assignments are independently reproducible by the Data Safety Monitoring Board, the Food and Drug Administration, the European Medicines Agency, or any subsequent auditor without access to sponsor-internal systems. ICH E6(R3) Good Clinical Practice and the European Medicines Agency reflection paper on decentralized clinical trials are compliance-applicable.

### Regulatory Monte Carlo Risk-Valuation Simulation.

The invention is further applicable to regulatory Monte Carlo simulation pipelines in financial risk valuation, including Value-at-Risk, credit valuation adjustment, counterparty credit risk, and Fundamental Review of the Trading Book internal-models-approach simulations. In this embodiment, the model-risk-governance function pre-commits, before the Value-at-Risk window begins, the target block height, the extraction specification, and the inverse cumulative distribution function mapping from extracted ledger characters to the target distribution, the target distribution being selected from uniform, normal, Poisson, exponential, log-normal, and Student-t. Sample vectors (s_1, . . . , s_n) are produced by applying Method M1 or Method E-FE-1 to the target block hash and transforming each extracted value through the pre-committed inverse cumulative distribution function mapping. The resulting Monte Carlo path is bit-identically reproducible by any regulator with access to public blockchain nodes and the published extraction specification, supporting the reproducibility requirements of Federal Reserve Supervisory Letter SR 11-7 Model Risk Management Guidance, United Kingdom Prudential Regulation Authority Supervisory Statement SS1/23 Model Risk Management Principles for Banks, European Banking Authority Guidelines EBA/GL/2021/05, and the Basel Committee Fundamental Review of the Trading Book Internal Models Approach.

### Solvency II and NAIC Actuarial Monte Carlo.

The invention is further applicable to regulator-reproducible actuarial Monte Carlo simulation for insurance risk and capital-reserve modeling. In this embodiment, the actuarial function pre-commits the target block height, the extraction specification, and the inverse cumulative distribution function mapping to the actuarial distribution, including log-normal claim severity, Poisson claim frequency, copula-based dependence, and extreme-value distributions. Sample vectors are produced by applying Method M1 to the target block hash and transforming each extracted value through the pre-committed inverse cumulative distribution function mapping, with the resulting paths bit-identically reproducible by regulators under the European Solvency II Directive 2009/138/EC Internal Model Application Process, the National Association of Insurance Commissioners Risk-Based Capital framework, the Swiss Financial Market Supervisory Authority Swiss Solvency Test, and the International Financial Reporting Standard 17 Contractual Service Margin reproducibility requirements.

### FDA Software-as-a-Medical-Device Imaging Augmentation.

The invention is further applicable to the generation of data-augmentation parameter vectors for medical-imaging neural-network training, including rotation, crop, flip, noise-magnitude, and elastic-deformation parameters. In this embodiment, each augmentation parameter is extracted natively within its per-parameter range from the target block hash via Method D1, M1, or E-FE-1, with the full augmentation parameter vector reproducible by any United States Food and Drug Administration reviewer, European Medicines Agency notified body, or third-party auditor under Software-as-a-Medical-Device Premarket Approval, 510(k) premarket notification, or Predetermined Change Control Plan, and under European Union Artificial Intelligence Act Annex III high-risk AI system Article 10 data governance requirements.

The many features and advantages of the invention are apparent from the above description. Numerous modifications and variations will readily occur to those skilled in the art. Since such modifications are possible, the invention is not to be limited to the exact construction and operation illustrated and described. Rather, the present invention should be limited only by the following claims.

What is claimed is:

1. A computer implemented method performed by a computing device coupled to a communications network for producing a verifiable random integer within a target range, the method comprising:
a) identifying the target range having a lower bound and an upper bound;
b) determining a source selection rule for selecting a public consensus derived cryptographic source value from a public consensus source;
c) determining an extraction specification that defines a deterministic mapping from the public consensus derived cryptographic source value to an integer within the target range;
d) before a candidate source value selected according to the source selection rule is confirmed, finalized, or otherwise fixed by the public consensus source, making the source selection rule and the extraction specification publicly available, cryptographically committed, or otherwise deterministically knowable to a verifier;
e) retrieving the candidate source value from the public consensus source according to the source selection rule;
f) verifying that the candidate source value satisfies the source selection rule and has satisfied a confirmation, finality, or consensus validity condition of the public consensus source;
g) applying the extraction specification to the candidate source value to produce the verifiable random integer within the target range; and
h) providing verification information sufficient for the verifier to reproduce the verifiable random integer from at least the candidate source value, the source selection rule, and the extraction specification,
i) wherein the verification information enables reproduction of the verifiable random integer without access to a secret cryptographic key and without reliance on a trusted randomness oracle.

2. The method of claim 1, wherein the public consensus derived cryptographic source value comprises one of a transaction hash, a block hash, a transaction Merkle root, a content identifier, a randomness beacon round signature, a verifiable random function output, a tipset key hash, a checkpoint digest, a smart contract event hash, a wallet creation transaction hash, or a contract creation transaction hash.

3. The method of claim 1, wherein the public consensus source comprises a distributed ledger, a decentralized storage network, a randomness beacon, a proof of work blockchain, a proof of stake blockchain, a BFT consensus network, a DAG based consensus network, a ZK native ledger, or a plugin defined public consensus source.

4. The method of claim 1, wherein the source selection rule identifies a consensus ordering criterion comprising a block height, slot, epoch, round, checkpoint, tipset, transaction index, event position, beacon round, content reference, or other public ordering criterion.

5. The method of claim 1, wherein the verification information comprises a proof record identifying the candidate source value, the source selection rule, the extraction specification, the confirmation, finality, or consensus validity condition, and the verifiable random integer.

6. The method of claim 1, wherein the extraction specification identifies a sequence of character positions in an encoded representation of the candidate source value.

7. The method of claim 6, wherein applying the extraction specification comprises selecting characters at the sequence of character positions and producing the verifiable random integer from the selected characters.

8. The method of claim 1, wherein the target range comprises a percentage range, a dice range, a lottery ball range, a card suit range, a card rank range, a byte range, or a threshold range.

9. The method of claim 1, wherein the extraction specification identifies a sliding window of digit characters in an encoded representation of the candidate source value, and wherein a digit window producing a value outside the target range is rejected and another digit window is evaluated.

10. The method of claim 1, further comprising classifying an encoding class of the candidate source value and selecting, based on the classified encoding class, a representation of the candidate source value or an extraction function to be used by the extraction specification.

11. The method of claim 10, further comprising generating both a canonical byte representation and a retained encoded string representation of the candidate source value.

12. The method of claim 11, wherein the extraction specification identifies whether the selected extraction function is applied to the canonical byte representation or to the retained encoded string representation.

13. The method of claim 10, wherein the encoding class comprises HEX, Base58, Base64, Base32, Bech32, balanced ternary trytes, field element, post quantum output, or plugin defined encoding.

14. The method of claim 10, wherein selecting the extraction function based on the classified encoding class comprises selecting an encoding specific extraction function corresponding to the classified encoding class.

15. The method of claim 1, wherein verifying that the candidate source value has satisfied the confirmation, finality, or consensus validity condition comprises applying a network specific confirmation depth, finality, or consensus validity gate.

16. The method of claim 1, wherein the verification information includes light client proof material comprising at least one of a block header, a Merkle inclusion proof, a validator signature, a checkpoint proof, a beacon signature, a milestone proof, or a finality proof.

17. The method of claim 1, further comprising applying the extraction specification or one or more additional extraction specifications to a plurality of public consensus derived cryptographic source values to produce a plurality of extracted values, and computing a combined entropy root from the plurality of extracted values.

18. The method of claim 17, further comprising sorting source records associated with the plurality of extracted values according to a canonical ordering rule before computing the combined entropy root.

19. The method of claim 1, further comprising deriving a plurality of domain separated seeds from the verifiable random integer, wherein each domain separated seed is derived by applying a cryptographic derivation function to the verifiable random integer and a respective domain tag, and wherein different domain tags produce different seed values for different stochastic domains.

20. The method of claim 19, wherein the different stochastic domains comprise at least two of weight initialization, dropout mask generation, data shuffling, data augmentation, optimizer perturbation, reinforcement learning exploration, RLHF sampling, diffusion noise generation, inference time reasoning path selection, or speculative decoding.

21. A computer implemented method performed by a computing device coupled to a communications network for producing verifiable random outputs from a public consensus source, the method comprising:
a) retrieving a public consensus derived cryptographic source value from the public consensus source;
b) verifying that the public consensus derived cryptographic source value has satisfied a confirmation, finality, or consensus validity condition of the public consensus source;
c) classifying an encoding class of the public consensus derived cryptographic source value;
d) generating, based on the classified encoding class, a first representation of the public consensus derived cryptographic source value comprising a canonical byte representation;
e) retaining, based on the classified encoding class, a second representation of the public consensus derived cryptographic source value comprising an original encoded string representation;
f) applying a first extraction function to the first representation to produce a first verifiable random output;
g) applying a second extraction function different from the first extraction function to the second representation to produce a second verifiable random output; and
h) providing verification information sufficient to reproduce the first verifiable random output and the second verifiable random output from the public consensus derived cryptographic source value.

22. A computer implemented method performed by a computing device for deriving reproducible domain separated seeds from a public consensus source, the method comprising:
a) identifying a source selection rule for selecting a public consensus derived cryptographic source value from the public consensus source;
b) identifying an extraction specification that defines a deterministic extraction of a verified entropy value from the public consensus derived cryptographic source value;
c) before a candidate source value selected according to the source selection rule is confirmed, finalized, or otherwise fixed by the public consensus source, making the source selection rule and the extraction specification publicly available, cryptographically committed, or otherwise deterministically knowable to a verifier;
d) retrieving the candidate source value from the public consensus source according to the source selection rule;
e) verifying that the candidate source value satisfies the source selection rule and has satisfied a confirmation, finality, or consensus validity condition of the public consensus source;
f) applying the extraction specification to the candidate source value to produce the verified entropy value;
g) identifying a plurality of stochastic domains for which different seed values are to be generated;
h) for each stochastic domain of the plurality of stochastic domains, selecting a respective domain tag;
i) deriving, for each stochastic domain, a respective domain separated seed by applying a cryptographic derivation function to at least the verified entropy value and the respective domain tag;
j) wherein the same verified entropy value is used to derive the respective domain separated seeds for the plurality of stochastic domains, and wherein different domain tags cause different seed values to be produced for different stochastic domains; and
k) generating verification information that enables a verifier to reproduce the verified entropy value and verify that the respective domain separated seeds were derived from the verified entropy value using the respective domain tags.
